(19) United States
(12) Patent Application Publication
(10) Pub. No.: US 2020/0221174 A1
(43) Pub. Date: Jul. 9, 2020

(54) INFORMATION PROCESSING APPARATUS, TERMINAL APPARATUS, INFORMATION PROVIDING SYSTEM, PROGRAM FOR CAUSING COMPUTER TO FUNCTION AS INFORMATION PROCESSING APPARATUS, RECORDING MEDIUM, AND METHOD FOR CONTROLLING INFORMATION PROCESSING APPARATUS

(71) Applicant: SHARP KABUSHIKI KAISHA, Sakai City, Osaka (JP)

(72) Inventor: YUKI FUJIWARA, Sakai City, Osaka (JP)

(21) Appl. No.: 16/628,535

(22) PCT Filed: Jun. 25, 2018
(86) PCT No.: PCT/JP2018/024037

§ 371 Date: Jan. 3, 2020

(30) Foreign Application Priority Data
Jul. 14, 2017 (JP) 2017-138369

(51) Int. Cl. H04N 21/442; H04N 21/443

(52) U.S. Cl. CPC H04N 21/44218; H04N 21/44222; H04N 21/4438

(57) ABSTRACT

Disclosed is converting solidarity in regard to an event into a numerical form. An information processing apparatus 10 includes: a communication section (11) configured to communicate with a terminal apparatus(es) (20); a storage section (13) configured to store therein an association between an event and the terminal apparatus(es) (20); and a control section (12) configured to acquire a piece of data on a behavior of a user from the terminal apparatus(es) (20) via the communication section (11), and find an indicator that is indicative of solidarity in regard to the event while referring to predetermined reference data and the piece of data on the behavior of the user thus acquired.

### TECHNICAL FIELD

The present invention relates to an information processing apparatus, a terminal apparatus, an information providing system, a program for causing a computer to function as an information processing apparatus, a program for causing a computer to function as a terminal apparatus, and a method of controlling an information processing apparatus.

### BACKGROUND ART

The following conventional technique, with regard to an event such as a sport or a concert which is being watched on a television or on the web, is known: the odds of winning or losing are inputted or information about cheering is inputted with use of a remote controller or a terminal device; pieces of such information are collected and thereby information about cheering is generated; and the generated information is reflected in an event site such as a sport site or a concert site in the form of shouts of joy, displaying a voting status on an electronic board, or the like (for example, see Patent Literature 1).

### CITATION LIST

### Patent Literature

### [Patent Literature 1]

Japanese Patent Application Publication, Tokukai, No. 2005-339479 (Publication date: Dec. 8, 2005)

### SUMMARY OF INVENTION

### Technical Problem

There is a tendency that solidarity is considered important in events such as sport events and concert events. However, information about cheering, such as the odds of winning or losing made by television/web viewers and votes that are indicative of which team the viewers are cheering for, is indicative of none of the following: solidarity among audience members, solidarity between an audience and the television/web viewers, and solidarity among television/web viewers, with regard to an excited atmosphere at the event site. Furthermore, such solidarity can be felt only through an atmosphere based on the sound of cheering and the volume of applause at an event site, and how the solidarity is felt varies among individuals.

The present invention was made in view of the above circumstances, and an object thereof is to provide an information processing apparatus that is capable of converting solidarity in regard to an event into a numerical form.

### Solution to Problem

In order to attain the above object, an information processing apparatus in accordance with the present invention includes: a communication section configured to communicate with a terminal apparatus; a storage section configured to store therein an association between an event and the terminal apparatus; and a control section configured to: acquire a piece of data on a behavior of a user from the terminal apparatus via the communication section, and find an indicator that is indicative of solidarity in regard to the event while referring to predetermined reference data and the piece of data on the behavior of the user thus acquired.

In order to attain the above object, a terminal apparatus in accordance with the present invention includes: a communication section configured to communicate with an information processing apparatus; a behavior detecting section configured to detect a behavior of a user; and a control section configured to supply, to the information processing apparatus via the communication section, a piece of data on the behavior of the user detected by the behavior detecting section.

In order to attain the object, a terminal apparatus in accordance with the present invention is a terminal apparatus that is associated with an event, the terminal apparatus including: a communication section configured to communicate with an information processing apparatus; a behavior detecting section configured to detect a behavior of a user; and a control section configured to: (i) acquire, via the communication section, data on a behavior of a user of the terminal apparatus, the data having been compiled by the information processing apparatus and being used as compiled data, (ii) refer to the compiled data and data on the behavior of the user detected by the behavior detecting section, and (iii) find an indicator that is indicative of solidarity for the user or for all users in regard to the event.

In order to attain the above object, an information processing system in accordance with the present invention includes: an information processing apparatus that includes a communication section, a control section, and an output section; and a terminal apparatus which is associated with an event, the control section being configured to: (i) find an indicator that is indicative of solidarity for a user of the terminal apparatus or for all users of two or more of the terminal apparatuses in regard to the event while referring to data on a behavior of the user acquired by the communication section; and (ii) supply the indicator thus found to one or more of the terminal apparatuses.

In order to attain the above object, an information processing system in accordance with the present invention includes: an information processing apparatus that includes a communication section and a control section; a terminal apparatus which is associated with an event; and an external server, the control section being configured to: (i) find an indicator that is indicative of solidarity for a user of the terminal apparatus or for all users of two or more of the terminal apparatuses in regard to the event while referring to data on a behavior of the user acquired by the communication section, and (ii) supply the indicator thus found to at least one of (a) one or more of the terminal apparatuses and (b) one or more of the external servers.

### Advantageous Effects of Invention

An aspect of the present invention makes it possible to provide an information processing apparatus that is capable of converting solidarity in regard to an event into a numerical form.

### BRIEF DESCRIPTION OF DRAWINGS

FIG. 1 is a block diagram illustrating a configuration of main parts of an information processing system in accordance with Embodiment 1.

(a) and (b) of FIG. 2 show data tables stored in a storage section.

FIG. 3 schematically illustrates an overview of an information processing system.

FIG. 4 schematically illustrates an overview of an information processing system.

FIG. 5 is a chart showing a sensor signal obtained by an oscillating motion detecting section.

FIG. 6 is a sequence diagram showing a process of finding an indicator indicative of solidarity.

FIG. 7 is a chart showing a weight function f(x).

FIG. 8 shows tables of factors that vary in accordance with situations of a baseball game. (a) of FIG. 8 is a table containing factors that vary in accordance with respective runner-on-base situations. (b) of FIG. 8 is a table containing factors that vary in accordance with respective OUT counts.

FIG. 9 illustrates examples of an indicator indicative of solidarity displayed on a display section.

FIG. 10 illustrates another example of the indicator indicative of solidarity displayed on the display section.

(a) through (c) of FIG. 11 illustrate other examples of the indicator indicative of solidarity displayed on the display section.

(a) and (b) of FIG. 12 illustrate other examples of the indicator indicative of solidarity displayed on the display section.

FIG. 13 shows a sensor signal of a terminal apparatus in accordance with Embodiment 2. (a) of FIG. 13 shows oscillating motion of a parent terminal apparatus, and (b) of FIG. 13 shows oscillating motion of a child terminal apparatus.

(a) through (c) of FIG. 14 illustrate other examples the indicator indicative of solidarity displayed on the display section.

FIG. 15 is a sequence diagram showing a process of finding an indicator indicative of solidarity in accordance with Embodiment 3.

FIG. 16 is a block diagram illustrating a configuration of main parts of an information processing system in accordance with Embodiment 4.

FIG. 17 is a sequence diagram showing a process of finding an indicator indicative of solidarity in accordance with Embodiment 4.

FIG. 18 is a block diagram illustrating a configuration of main parts of an information processing system in accordance with Embodiment 5.

FIG. 19 is a block diagram illustrating a configuration of main parts of an information processing system in accordance with Embodiment 6.

FIG. 20 is a block diagram illustrating an example configuration of a computer by which an information processing apparatus, a terminal apparatus, and an external server and can be realized.

### DESCRIPTION OF EMBODIMENTS

### Embodiment 1

The following description will discuss Embodiment 1 of the present invention in detail.

[Overview of Information Processing System]

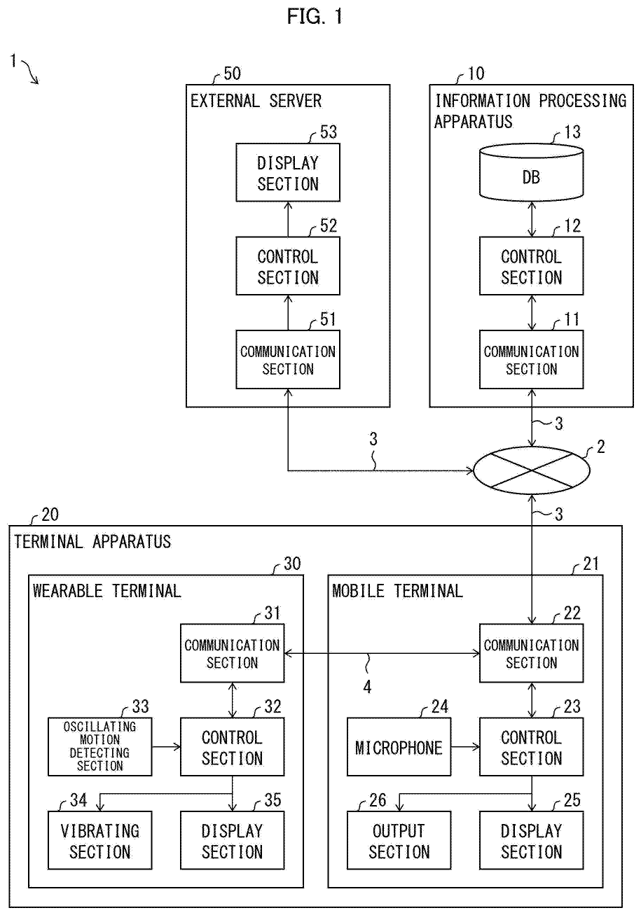

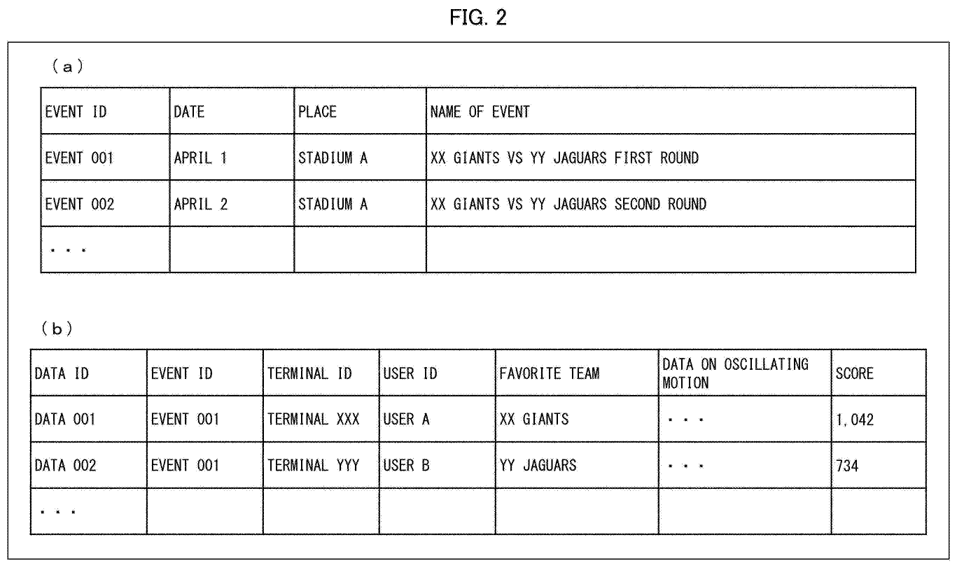

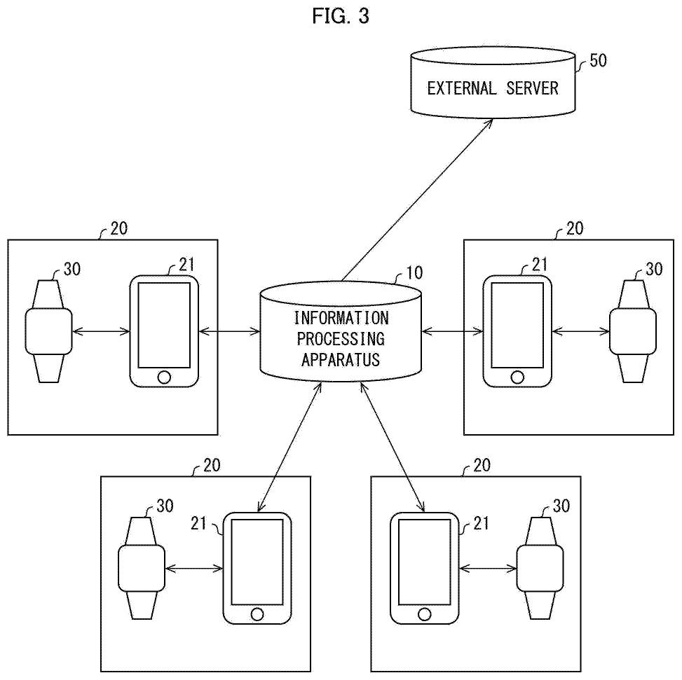

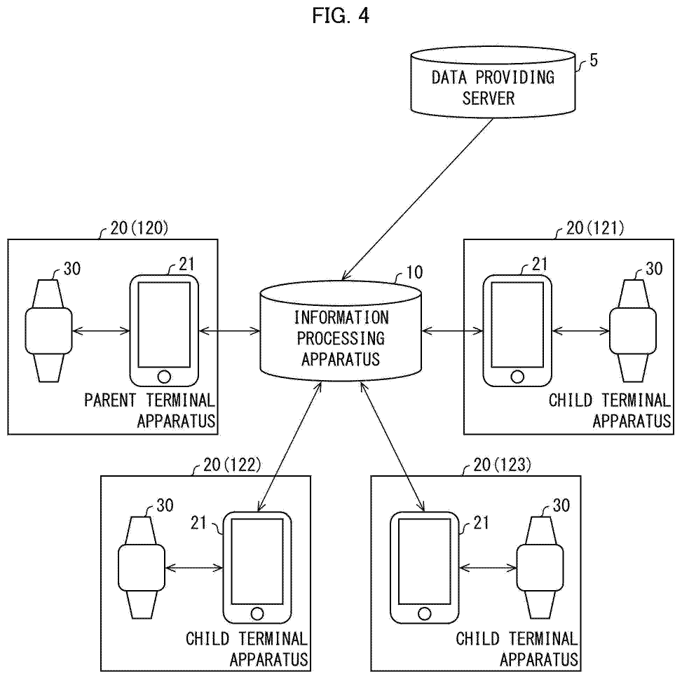

FIG. 1 is a block diagram illustrating a configuration of main parts of an information processing system in accordance with Embodiment 1. FIGS. 3 and 4 each schematically illustrate an overview of an information processing system 1.

As illustrated in FIG. 1, the information processing system 1 includes an information processing apparatus 10, a terminal apparatus 20, and an external server 50. The information processing system 1 is configured such that the information processing apparatus 10, the terminal apparatus 20, and the external server 50 are communicable with each other through radio communication links 3 over a network 2.

The information processing system 1 can be configured such that an information processing apparatus 10 is communicably connected to a terminal apparatus(es) 20 (see FIG. 3).

The information processing system 1 can be configured such that at least one terminal apparatus(es) 20, which are communicably connected to an information processing apparatus 10, is recognized as a parent terminal apparatus 120 (see FIG. 4). Such a configuration can be arranged such that the other terminal apparatuses 20, which are different from the parent terminal apparatus 120, are recognized as respective child terminal apparatuses 121, 122, 123, and so on.

The information processing system 1 can be configured such that the information processing apparatus 10 receives data from an external data providing server 5 (not illustrated). The data providing server 5 is a server that, for example, in a case of a sport event, provides information about athletes and/or details of the athletes' performance (such information is so-called “statistics” information). The data providing server 5 is communicably connected to the information processing apparatus 10 over the network 2. Note that the information processing apparatus 10 can be configured to function as a data providing server 5 which collects data from a plurality of data sources.

The information processing apparatus 10 of the information processing system 1 functions as a server which resides on the network 2 and via which the terminal apparatuses 20 share information with each other. The information processing apparatus 10 of the information processing system 1 also functions as a server which resides on the network 2 and via which the terminal apparatus(es) 20 and the external server 50 share information with each other.

The terminal apparatus 20 includes a mobile terminal 21 and a wearable terminal 30. The mobile terminal 21 and the wearable terminal 30 are communicably connected to each other via a near field communication link 4. The mobile terminal 21 and the wearable terminal 30 can be connected to each other via, for example, Bluetooth (registered trademark) or ANT, each of which is a low power-consumption version of the near field communication link 4.

The mobile terminal 21 and the wearable terminal 30 can be integrally configured. In such a configuration, a control section 32 and a control section 23 are integrally provided and a display section 35 and a display section 25 are integrally provided. Note that a communication section 31 is not essential.

The terminal apparatus 20 is associated with a corresponding event. This intends to mean a situation in which a user of a terminal apparatus 20 is participating in the event. Such a situation encompasses a situation in which (i) information about the terminal apparatus and (ii) information about the event in which the user is participating are stored in the information processing apparatus 10 so as to be associated with each other. Note that the situation, in which a user is participating in an event, can encompass a situation in which information about the event is stored in the user's terminal apparatus 20.

In this specification, examples of the “event” encompass a sport and a music live show (i.e., concert). Examples of the situation, in which the user is participating in an event, encompass (i) a case where the user is participating in the event at the event site and (ii) a case where the user is participating in the event at a remote site.

The information processing system 1 stores therein an association between an event and the terminal apparatus(es) 20 (details of the association will be described later). The information processing system 1 is configured to (i) acquire a piece(s) of data on a behavior(s) of the user(s) of the terminal apparatus(es) 20 associated with the event from the apparatus(es) 20 via a communication section 11, (ii) refer to predetermined reference data and the thus-acquired piece(s) of data, and (iii) find an indicator indicative of solidarity (such an indicator hereinafter may be referred to as “solidarity indicator”) in regard to the event.

Note that in this specification, the “behavior of a user” encompasses (i) the user's simply swinging his/her arm up and down, (ii) more complex motions such as twisting the arm and jumping, a dance with a specific pattern (not a dance with periodic motions), and (iii) an encouraging shout by the user. The terminal apparatus(es) 20 is configured to be capable of detecting data on such behaviors of the user through use of detectors such as an acceleration sensor, an orientation sensor, and/or a microphone. An oscillating motion detecting section 33 (described later) is merely an example of a feature that detects the data on such a behavior of the user, and may also be referred to as a behavior detecting section.

In Embodiment 1, the information processing apparatus 10 finds the solidarity indicator while referring to a piece(s) of data on oscillating motion (i.e., an example of data on a behavior of a user) of the terminal apparatus(es) 20. The information processing apparatus 10 transmits, to the terminal apparatus(es) 20, the solidarity indicator that has been found while referring to the piece(s) of data on oscillating motion of the terminal apparatus(es) 20. The information processing apparatus 10 also provides the solidarity indicator to the external server 50.

Note that the term “oscillating motion” refers to a motion in which a user periodically changes his/her behavior from one certain basic state to another, such as a motion of a pendulum. Examples of the “oscillating motion” encompass a periodic change in acceleration of the terminal which periodic change is detected when a user swings his/her arm periodically upward, downward, rightward and/or leftward to music played at an event site.

The external server 50 functions as, for example, a server that resides on the network 2 and that provides information to a facility for an audience, such as a concert site or a stadium. Data which the external server 50 receives from the information processing apparatus 10 over the network 2 is displayed on a display section 53 and is thereby provided to the audience. The display section 53 is a large-scale video screen such as Diamond Vision (Aurora Vision) installed in the facility.

[Configuration of Main Parts of Information Processing Apparatus] As illustrated in FIG. 1, the information processing apparatus 10 includes the communication section (acquiring section, output section) 11, a control section 12, and a storage section (DB) 13. The description in Embodiment 1 discusses with the example in which the number of information processing apparatuses 10 included in the information processing system 1 is one (1). However, the present invention is not limited as such. For example, the following configuration can be employed: functional sections of the information processing apparatus 10 are realized by a plurality of different servers, that is, the information processing apparatus(es) 10 is/are realized by a plurality of servers. Alternatively, a configuration can be employed in which a plurality of information processing apparatuses 10 work together to carry out processes.

The communication section 11 communicates with (i) the terminal apparatus(es) 20 and (ii) the external server 50 via the radio communication links 3 over the network 2 such as the Internet. The communication section 11 also functions as an acquiring section configured to acquire information from the terminal apparatus(es) 20 and from the external server 50 over the network 2. The communication section 11 also functions as an output section configured to output information to (i) the terminal apparatus(es) 20 and (ii) the external server 50 over the network 2.

The control section 12 is an arithmetic and logic unit that has a function of overall control of various sections of the information processing apparatus 10. The control section 12 is configured to control components of the information processing apparatus 10, by controlling, for example, a processor (e.g., CPU) to execute a program(s) stored in a memory (e.g., RAM, ROM).

The storage section 13 is a storage that stores therein various data for use in the control section 12. The storage section 13 is realized by, for example, EPROM, EEPROM (registered trademark), HDD, and flash memories, alone or in combination, all of which are rewritable nonvolatile memories.

(a) and (b) of FIG. 2 show data tables stored in the storage section 13. (a) of FIG. 2 shows an event information table that contains information about an event(s) therein. (b) of FIG. 2 shows a terminal-apparatus-related information table that contains therein information about each of the terminal apparatus(es) 20 in association with information about an event.

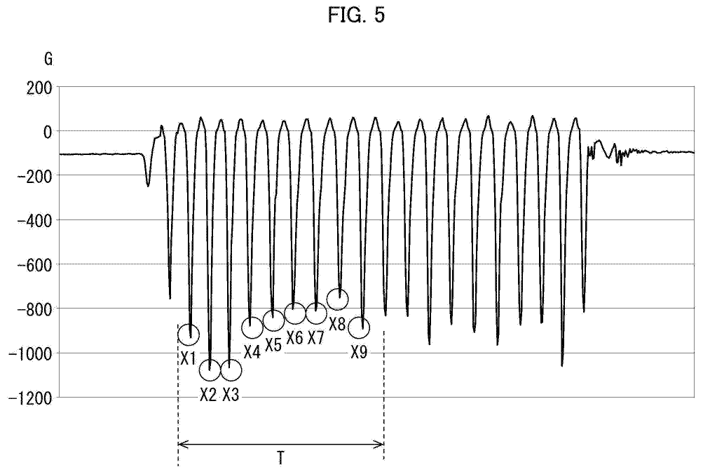

As shown in (a) of FIG. 2, the event information table, stored in the storage section 13, contains therein event information (including date of an event, place of the event, name of the event, and/or the like) in association with an event ID that identifies the event. As shown in (b) of FIG. 2, the terminal-apparatus-related information table, stored in the storage section 13, contains therein information on an association between an event and a terminal apparatus 20. The terminal-apparatus-related information table contains therein a terminal ID that is unique to the terminal apparatus 20, a user ID, a team that the user is cheering for (hereinafter referred to as “favorite team”), data on a behavior of the user, and information about score (described later), which are associated with a data ID and an event ID. The data on a behavior of a user can be unprocessed data of a sensor signal which is indicative of magnitude of acceleration detected by the oscillating motion detecting section 33 of the wearable terminal 30 (see FIG. 5). The data on a behavior of a user will be described later in detail.

[Overview of Terminal Apparatus]

Each terminal apparatus 20 includes the mobile terminal 21 and the wearable terminal 30. The mobile terminal 21 and the wearable terminal 30 are connected to each other so as to be capable of sharing information with each other, via the near field communication link 4 such as Bluetooth (registered trademark) or Wi-Fi (registered trademark). The mobile terminal 21 and the wearable terminal 30 are registered with each other, and are configured such that, in a case where the mobile terminal 21 and the wearable terminal 30 are within a distance that allows them to be connected to each other via the near field communication link 4, the mobile terminal 21 and the wearable terminal 30 recognize each other automatically or in response to a user's control and then enter into a connected state.

[Configuration of Main Parts of Mobile Terminal]

The mobile terminal 21 includes a communication section 22, the control section 23, a microphone 24, the display section 25, and an output section 26. The description in Embodiment 1 discusses with the example in which the mobile terminal 21 is realized by a smartphone. The present invention is, however, not limited as such. The mobile terminal 21 can alternatively be realized by, for example, a portable terminal such as a mobile phone or a tablet computer instead of the smartphone.

The communication section 22 communicates with the wearable terminal 30 via the near field communication link 4, and communicates with the information processing apparatus 10 via the radio communication links 3. The communication between the communication section 22 and the information processing apparatus 10 is not particularly limited, provided that the communication can be made over the network 2, for example, by the radio communication links 3 such as the Internet. The communication section 22 can be configured by a plurality of communication devices that include (i) a first communication device that functions as the near field communication link 4 and (ii) a second communication device that functions as the radio communication links 3.

The control section 23 is an arithmetic and logic unit that has a function of overall control of various sections of the mobile terminal 21. The control section is configured to control components of the mobile terminal 21 by controlling, for example, a processor (e.g., CPU) to execute a program(s) stored a memory (e.g., RAM, ROM).

The control section 23 processes various kinds of data which are (i) exchanged between the control section 23 and the information processing apparatus 10 via the communication section 22 and (ii) exchanged between the control section 23 and the wearable terminal 30 via the communication section 22. The control section 23 also controls the display section 25 and the output section 26 to output information in the form of display on a screen, in the form of a sound, in the form of a vibration of a vibrator, and/or the like. Such information is obtained by (i) exchanging between the control section 23 and the information processing apparatus 10 via the communication section 22 and (ii) exchanging between the control section 23 and the wearable terminal 30 via the communication section 22.

The microphone 24 is a device that collects and stores ambient sounds. The microphone 24 is, for example, a microphone that convers a sound signal into an electrical signal, and then stores therein the electrical signal.

The display section 25 is a display device that is capable of displaying an image in accordance with the control by the control section 23.

The output section 26 includes, for example, (i) a light emitting section including an LED, (ii) a sound output section including a speaker, and/or (iii) a vibrating section including a vibrator. The output section 26 is configured to produce an output in accordance with a control signal received from the control section 23 so as to control (i) the LED to emit light, (ii) the speaker to output a sound, and/or (iii) the vibrator to vibrate.

[Configuration of Main Parts of Wearable Terminal]

The wearable terminal 30 is a terminal device that can be worn on the body of a user. The wearable terminal 30 can be realized by, for example, a smartwatch that can be worn by wrapping a belt around a wrist of the user. The wearable terminal 30 includes the communication section 31, the control section 32, the oscillating motion detecting section 33, a vibrating section 34, and the display section 35.

The communication section 31 communicates with the communication section 22 of the mobile terminal 21 via the near field communication link 4 such as Bluetooth (registered trademark).

The control section 32 is an arithmetic and logic unit that has a function of overall control of various sections of the wearable terminal 30. The control section 32 is configured to control components of the wearable terminal 30, by controlling, for example, a processor (e.g., CPU) to execute a program stored in a memory (e.g., RAM, ROM).

The oscillating motion detecting section 33 detects an oscillating motion in accordance with a behavior of a user who is wearing the wearable terminal 30. The oscillating motion detecting section 33 at least includes an acceleration sensor. The oscillating motion detecting section 33 supplies, to the control section 32, a sensor signal indicative of detected acceleration. Note that a triaxial acceleration sensor can be preferably employed as the acceleration sensor. Note also that a biaxial acceleration sensor or a gyroscope sensor can be employed as the acceleration sensor, instead of the triaxial acceleration sensor.

The vibrating section 34 includes a vibrator so as to vibrate in accordance with a control signal received from the control section 32. The control section 32 controls the vibrating section 34 to vibrate in accordance with a signal received from the mobile terminal 21 which is in cooperation with the wearable terminal 30. This makes it possible to convey information to the user who wears the wearable terminal 30. For example, the terminal apparatus 20 is capable of achieving the following: in a case where the mobile terminal 21 (which is a smartphone) has received an incoming call or mail, the control section 32 controls the vibrating section 34 of the wearable terminal 30 to vibrate, so as to notify the user of an incoming call or mail.

The display section 35 is a display device that is capable of displaying an image in accordance with the control by the control section 32.

[Configuration of Main Parts of External Server 50]

The external server 50 collects information that is to be provided to a facility for audiences, such as a concert site and/or a stadium. The external server 50 includes a communication section 51, a control section 52, and the display section 53.

The communication section 51 communicates with the information processing apparatus 10 via the radio communication links 3 over a network such as the Internet.

The control section 52 is an arithmetic and logic unit that has a function of overall control of various sections of the external server 50. The control section 52 is configured to control components of the external server 50 by, for example, controlling a processor (e.g., CPU) to execute a program stored in a memory (e.g., RAM, ROM).

The display section 53 is a display device that is capable of displaying an image in accordance with the control by the control section 52. The display section 53 can be realized by a large-scale video screen such as Diamond Vision (Aurora Vision) installed in a facility for an audience such as a concert site or a stadium. The external server 50 controls the control section 52 in accordance with information acquired from the information processing apparatus 10. Then, the control section 52 controls the display section 53 to carry out display so as to present information to the audience.

[Data on Oscillating Motion]

FIG. 5 is a chart showing a sensor signal that is indicative of magnitudes of acceleration detected by the oscillating motion detecting section 33 of the wearable terminal 30. FIG. 5 shows a sensor signal obtained in a case where a user, who is wearing the wearable terminal on his/her wrist, has swung his/her arms continuously to beat time with his/her hands.

As shown in FIG. 5, in a case where the user swings his/her arms in a certain rhythm, the oscillating motion detecting section 33 causes the triaxial acceleration sensor to measure an acceleration vector so as to find a magnitude of acceleration. The magnitude of the acceleration is expressed in unit “G” which is based on standard gravity. The control section 32 controls the communication section 31 to supply to the mobile terminal 21, whenever necessary, the sensor signal thus detected by the oscillating motion detecting section 33 of the wearable terminal 30.

The sensor signal, detected by the oscillating motion detecting section 33 of the wearable terminal 30, is sent to the control section 23 via the communication section 22 of the mobile terminal 21. The control section 23 refers to the sensor signal thus acquired, and then finds the number of beats which is data on oscillating motion of the wearable terminal 30. Specifically, the control section 23 refers to the magnitudes of acceleration which have been determined in accordance with the sensor signal detected by the oscillating motion detecting section 33, and employs, as the number of beats B, the number of local minimums X within a unit time T. Each of the local minimums X is a point at which the magnitude of the acceleration, which has decreased, starts increasing. The number of beats B is indicative of the number of oscillations of the wearable terminal 30 within the unit time T.

The control section 23 of the mobile terminal 21 then provides the thus-found number of beats B to the information processing apparatus 10 via the communication section 22. The number of beats B serves as a piece of data on oscillating motion of a corresponding terminal apparatus 20.

The control section 23 of the mobile terminal 21 can provide, to the information processing apparatus 10 via the communication section 22, data which varies in accordance with magnitudes G of acceleration which vary in accordance with the wearable terminal 30 oscillating. For example, the control section 23 of the mobile terminal 21 can be configured to (i) refer to the sensor signal detected by the oscillating motion detecting section 33 of the wearable terminal 30 and (ii) supplies, to the information processing apparatus 10, at least one of the average of and addition of magnitudes G of acceleration at the local minimums X of the oscillating motion within the unit time T. The average and the addition of magnitudes G here serve as a piece of data on oscillating motion of a corresponding terminal apparatus 20.

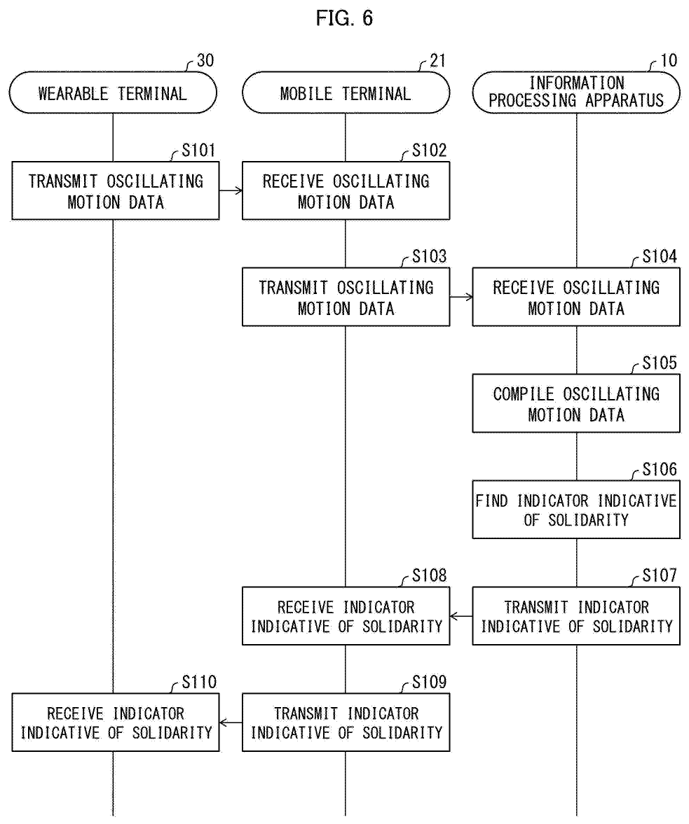

Embodiment 1 discusses a configuration in which the control section 23 of the mobile terminal 21 finds data on oscillating motion of the terminal apparatus 20. Note, however, that this does not intend to imply any limitation. For example, the following configuration can alternatively be employed: (i) the control section 32 of the wearable terminal 30 finds data on oscillating motion of the wearable terminal 30 in accordance with a sensor signal detected by the oscillating motion detecting section 33; and (ii) the control section 32 supplies the data to the information processing apparatus 10 via the mobile terminal 21.

[Process of Finding Solidarity Indicator by Use of Information Processing Apparatus] FIG. 6 is a sequence diagram showing a process of finding a solidarity indicator by use of the information processing system 1.

The following description will discuss steps of a process of finding a solidarity indicator in regard to a certain event, with reference to FIG. 6.

(Step S101)

The control section 32 of the wearable terminal 30 transmits a piece of data on oscillating motion to the mobile terminal 21 via the communication section 31, in accordance with a sensor signal detected by the oscillating motion detecting section 33.

(Step S102)

The control section 23 of the mobile terminal 21 receives the piece of data on oscillating motion from the wearable terminal 30 via the communication section 22.

(Step S103)

The control section 23 of the mobile terminal 21 transmits the piece of data on oscillating motion to the information processing apparatus 10 via the communication section 22.

Note that the terminal apparatus 20 transmits, as the data on oscillating motion of the terminal apparatus 20, to the information processing apparatus 10, at least one of (i) magnitudes G of acceleration caused by respective oscillations of the oscillating motion and (ii) the number of beats B which is indicative of the number of oscillations. Both of the above (i) and (ii) are determined in accordance with the sensor signal detected by the oscillating motion detecting section 33 of the wearable terminal 30. The piece of data on oscillating motion can alternatively be found by the control section 32 of the wearable terminal 30 or by the control section 23 of the mobile terminal 21.

The terminal apparatus 20 can transmit, to the information processing apparatus 10, the piece of data on oscillating motion which has added thereto information about a user of the terminal apparatus 20. Examples of the information about the user of the terminal apparatus 20 include a user name, a user ID, a user's favorite team, and/or the like.

(Step S104)

The control section 12 of the information processing apparatus 10 acquires the piece of data on oscillating motion from the terminal apparatus 20 via the communication section 11.

The information processing apparatus 10 acquires, from a terminal apparatus(es) 20, a piece(s) of such data on oscillating motion of the terminal apparatus(es) 20.

(Step S105)

The control section 12 of the information processing apparatus 10 compiles the piece(s) of data on oscillating motion of the terminal apparatus(es) 20 acquired via the communication section 11, based on an association between the terminal apparatus(es) 20 and an event(s).

(Step S106)

The control section 12 of the information processing apparatus 10 finds a solidarity indicator in regard to the event while referring to compiled data obtained in step S105 and certain reference data.

(Step S107)

The control section 12 of the information processing apparatus 10 transmits the thus-found solidarity indicator to the terminal apparatus(es) 20 via the communication section 11. Additionally, the control section 12 of the information processing apparatus 10 can transmit the thus-found solidarity indicator to the external server 50 via the communication section 11.

(Step S108)

The control section 23 of the mobile terminal 21 receives the solidarity indicator from the information processing apparatus 10 via the communication section 22. The control section 23 of the mobile terminal 21 can control the display section 25 to display the solidarity indicator thus received.

(Step S109)

The control section 23 of the mobile terminal 21 transmits the solidarity indicator to the wearable terminal 30 via the communication section 22.

(Step S110)

The control section 32 of the wearable terminal 30 receives the solidarity indicator via the communication section 31. The control section 32 of the wearable terminal 30 can control the display section 35 to display the solidarity indicator thus received.

[Method of Finding Solidarity Indicator]

The following description will discuss, with reference to FIGS. 4, 7 and 8, a method of finding a solidarity indicator in regard to a certain event.

As illustrated in FIG. 4, the control section 12 of the information processing apparatus 10 acquires, from a plurality of terminal apparatuses 20 via the communication section 11, pieces of data on oscillating motion of the respective plurality of terminal apparatuses 20.

The control section 12 of the information processing apparatus 10 recognizes, as a parent terminal apparatus 120, at least one of the plurality of terminal apparatuses 20. The parent terminal apparatus 120 can be configured to add, to the piece of data on oscillating motion thereof, information that identifies that this piece of data belongs to the parent terminal apparatus 120, and then transmit this piece of data on oscillating motion to the information processing apparatus 10.

The parent terminal apparatus 120 is a terminal apparatus 20 that is carried by, for example, in a case of sport game watching, a percussionist of a cheering team. In such a case, the parent terminal apparatus 120 supplies, to the information processing apparatus 10, a piece of data on oscillating motion based on a sensor signal detected by the oscillating motion detecting section 33 of the wearable terminal 30 worn by the percussionist. Hereinafter the number of oscillations within a unit time T (this number is a piece of data on oscillating motion of the parent terminal apparatus 120) is referred to as the number of beats Bm.

The control section 12 of the information processing apparatus 10 recognizes, as child terminal apparatuses 121, 122, 123 and so on, the rest of the plurality of terminal apparatuses 20 (other than the terminal apparatus 20 having been recognized as the parent terminal apparatus 120). The child terminal apparatuses 121, 122, and 123 and so on are, for example, in a case of sport game watching, terminal apparatuses 20 that are worn by fans who cheer together with the cheering team. Specifically, the information processing apparatus 10 receives pieces of data on oscillating motion from the respective n child terminal apparatuses 121, 122, 123 and so on (n corresponds to the number of fans who carry the terminal apparatuses 20).

The child terminal apparatuses 121, 122, and 123 supply, to the information processing apparatus 10, the pieces of data on oscillating motion each based on a sensor signal detected by the oscillating motion detecting section 33 of the wearable terminal 30 worn by each of the fans. Note, here, that the number of oscillations within a unit time T (the number is a piece of data on oscillating motion) of each of the child terminal apparatuses 121, 122, and 123 is used as the number of beats Bn. For example, the number of oscillations of the child terminal apparatus 121 within the unit time T can be expressed as the number of beats B₁₂₁, and the number of oscillations of the child terminal apparatus 122 within the unit time T can be expressed as the number of beats B₁₂₂.

The control section 12 of the information processing apparatus 10 compiles (i) the number of beats Bm which (a) is a piece of data on a behavior of a user of the parent terminal apparatus 120 and (b) has been acquired from the parent terminal apparatus 120 and (ii) the number of beats Bn which (a) is a piece of data on a behavior of a user of each of the child terminal apparatuses 121, 122, and 123 and (b) has been acquired from each of the child terminal apparatuses 121, 122, and 123. Next, the control section 12 of the information processing apparatus 10 finds a difference between (i) the number of beats Bn of each of the child terminal apparatuses 121, 122, and 123 and (ii) the number of beats Bm of the parent terminal apparatus 120 (the number of beats Bm here is used as reference data). That is, the control section 12 finds a difference between the number of beats Bm and the number of beats Bn through the equation “Difference=(Bm−Bn)”.

Next, the control section 12 of the information processing apparatus 10 finds a score Sn for each of the child terminal apparatuses 121, 122, and 123. The score Sn is obtained with use of “Bm-Bn” having a weight function f(x) applied thereto. Specifically, the score Sn is found in accordance with the equation “Score Sn=f(Bm-Bn)”. The control section 12 of the information processing apparatus 10 finds the score Sn for each of the child terminal apparatuses 121. The control section 12 of the information processing apparatus 10 then finds the sum ΣSₙ^{m} of the scores Sn for all the child terminal apparatuses 121. The sum ΣSₙ^{m} serves as a solidarity indicator.

With the above configuration, with regard to a certain event, a solidarity indicator is found while referring to (i) reference data which is the number of beats Bm of the parent terminal apparatus 120 and (ii) the number of beats Bn which is a piece of data on a behavior (such as beating time with hands) of each user. That is, a piece of data on a behavior of a user of the parent terminal apparatus 120 (i.e., “another user” which is other than the users of the child terminal apparatuses 121, 122, and 123) is acquired as a piece of reference data from the parent terminal apparatus 120 via the communication section 11, and the score Sn of each of the child terminal apparatuses 121, 122, and 123 is found. This makes it possible to convert solidarity, which originally is intangible, into a numerical form, and thus allows users to feel solidarity more accurately.

The solidarity indicator, as described above, is found in accordance with the difference (Bm-Bn) between (i) the number of beats Bm of the parent terminal apparatus 120 within a unit time T and (ii) the number of beats Bn of each of the child terminal apparatuses 121, 122, and 123 within the unit time T. That is, the solidarity indicator is found based on the number of oscillations of each of the terminal apparatuses 20 within the unit time T. This configuration makes it possible to find a solidarity indicator without requiring precise time information. For example, in a case of attending a sport game at a large stadium, a time lag will occur in beat between a percussionist of a cheering team and a fan distant from the percussionist. In such circumstances in which a time lag in response occurs between the parent terminal apparatus 120 and respective of the child terminal apparatuses 121, 122, and 123, by finding a solidarity indicator in accordance with the number of oscillations of each of the terminal apparatuses 20 within the unit time T, it becomes possible to find the most accurate solidarity indicator.

Note that the reference data is not limited to data on a behavior of the user of the parent terminal apparatus 120 acquired via the communication section 11, and can alternatively be data pre-stored in the storage section 13. The storage section 13 can store therein, for example, reference data found by statistical processing. The reference data can be found based on a piece(s) of data on a behavior(s) of a user(s) of a terminal apparatus(es) 20 acquired via the communication section 11 in a past event(s).

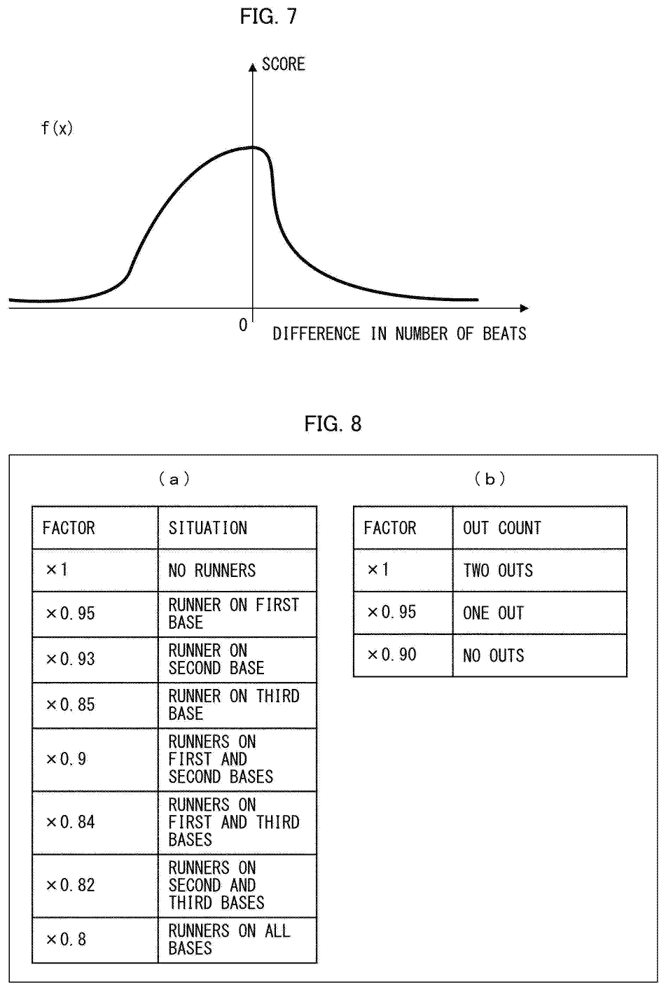

FIG. 7 is a chart showing the weight function f(x). The weight function f(x) is set so that the score Sn is found to be higher, as the difference (Bm-Bn) between the number of beats Bm of the parent terminal apparatus 120 and the number of beats Bn of each of the child terminal apparatus 121, 122, and 123 decreases. The weight function f(x) is also set so that, in a case where absolute values of the difference (Bm-Bn) are identical, the score Sn becomes higher (i) in a case where the number of beats Bn of each of the child terminal apparatuses 121, 122, and 123 is larger than the number of beats Bm of the parent terminal apparatus 120 than (ii) in a case where the number of beats Bn of each of the child terminal apparatuses 121, 122, and 123 is smaller than the number of beats Bm of the parent terminal apparatus 120.

Furthermore, the control section 12 of the information processing apparatus 10 makes the solidarity indicator more dependent on situations, by multiplying (i) the sum ΣSₙ^{m} of the scores Sn of all the child terminal apparatuses 121, 122, and 123 by (ii) a factor that varies in accordance with situations. FIG. 8 shows specific examples of such a factor that varies in accordance with situations. The specific examples of the factor shown in FIG. 8 are those for a case of a baseball game.

(a) of FIG. 8 shows factors that vary in accordance with respective runner-on-base situations. (b) of FIG. 8 shows factors that vary in accordance with respective OUT counts. The control section 12 of the information processing apparatus 10, in a case of a baseball game, multiplies the sum ΣSₙ^{m} of the scores Sn of all the child terminal apparatuses 121, 122, and 123 by a factor that varies in accordance with runner-on-base situations and by a factor that varies in accordance with OUT counts. With this, the control section 12 of the information processing apparatus 10 controls the solidarity indicator in accordance with game situations. As such, the solidarity indicator is found to be low in cases where an audience is more required to cheer as one for their team. This makes it possible to encourage more cheering.

[Example of how Solidarity Indicator is Displayed]

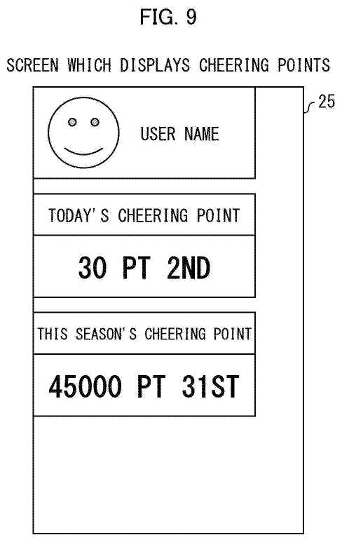

FIGS. 9 through 12 illustrate examples of how a found solidarity indicator of a user in regard to an event is displayed.

The control section 12 of the information processing apparatus 10 can be configured to (i) find the degree of contribution of each of the terminal apparatuses 20 to the sum ΣSₙ^{m} of the scores Sn of the respective child terminal apparatuses 121, 122, and 123 and (ii) employ the degree of contribution as a solidarity indicator. For example, the storage section 13 of the information processing apparatus 10 stores therein a table that associates each score Sn with a corresponding degree of contribution to the sum ΣSₙ^{m}. For example, in the table, the degree of contribution corresponding to the score Sn can increase as the sum ΣSₙ^{m} increases.

The control section 12 of the information processing apparatus 10 can be configured to, while referring to the table which is stored in the storage section 13 and which associates each score Sn with a corresponding degree of contribution, find earned points that vary in accordance with the degree of contribution of each of the child terminal apparatuses 121, 122, and 123. The control section 12 of the information processing apparatus 10 can be configured to supply, to each of the child terminal apparatuses 121, 122, and 123 via the communication section 11, the thus-found earned points serving as a solidarity indicator.

The storage section 13 of the information processing apparatus 10 is managed to store therein the earned points, which have been found by the control section 12, such that the points are managed to be stored on a per-event-date basis and a per-user basis. The control section 12 of the information processing apparatus 10 is capable of, while referring to information of the earned points stored in the storage section 13, determining (i) points earned by a user in the today's event and the rank of the user among all users in the today's event in terms of the number of earned points and (ii) points earned by the user in this season and the rank of the user among all the users in this season in terms of the number of earned points.

The control section 12 of the information processing apparatus 10 supplies, to each of the terminal apparatuses 20 via the communication section 11, information about earned points which have been determined as the solidarity indicator.

FIG. 9 illustrates examples of the solidarity indicator displayed on the display section 25 of the mobile terminal 21.

Each of the terminal apparatuses 20 supplies the solidarity indicator, which has received from the information processing apparatus 10, to a user thereof by causing on at least one of (i) the display section 25 of the mobile terminal 21 and (ii) the display section 35 of the wearable terminal 30 to display the solidarity indicator.

As illustrated in FIG. 9, the control section 23 of the mobile terminal 21 controls the display section 25 to display solidarity indicators acquired via the communication section 22. For example, the control section 23 of the mobile terminal 21 controls the display section 25 to display (i) a user name; (ii) the points earned by a user in the today's event and the rank of the user among all users in the today's event in terms of the number of earned points; and (iii) the points earned by the user in this season and the rank of the user among all the users in this season in terms of the number of earned points.

Such earned points can be used by the user for, for example, a player popularity poll. Points that have been earned by players in the player popularity poll are managed to be stored on a per-player basis in the storage section 13 of the information processing apparatus 10.

The control section 12 of the information processing apparatus 10 is capable of, while referring to information of the earned points stored in the storage section 13, determining (i) the total number of points earned so far by a user, (ii) the number of used earned points, and (ii) the number of remaining earned points. Upon receipt of a request for point confirmation from the user via the terminal apparatus 20, the control section 12 refers to information of points which are earned by the user and stored in the storage section 13. Then, the control section 12 determines (i) the total number of points earned so far by the user, (ii) the number of used earned points, and (iii) the number of remaining earned points. The control section 12 then transmits the thus-determined information to the user's terminal apparatus 20. The user can conduct, for example, an operation so as to use remaining earned points for a player popularity poll, through either the mobile terminal 21 or the wearable terminal 30.

In a case where the user conducts the operation so as to use remaining earned points for a player popularity poll through the terminal apparatus 20, the terminal apparatus 20 supplies, to the control section 12 via the communication section 11, (i) user information, (ii) the number of points the user wants to use for the poll, and (iii) information about a player the user votes for. The control section 12 of the information processing apparatus 10 acquires the user information, the number of points the user wants to use for the poll, and the information about the player, and manages (i) points earned by players in the popularity poll stored on a per-player basis and (ii) the number of earned points of the user who has voted for the player, both of which are stored in the storage section 13. The control section 12 of the information processing apparatus 10 supplies, to the terminal apparatus 20 via the communication section 11, information about the points earned by the players in the popularity poll stored on a per-player basis in the storage section 13.

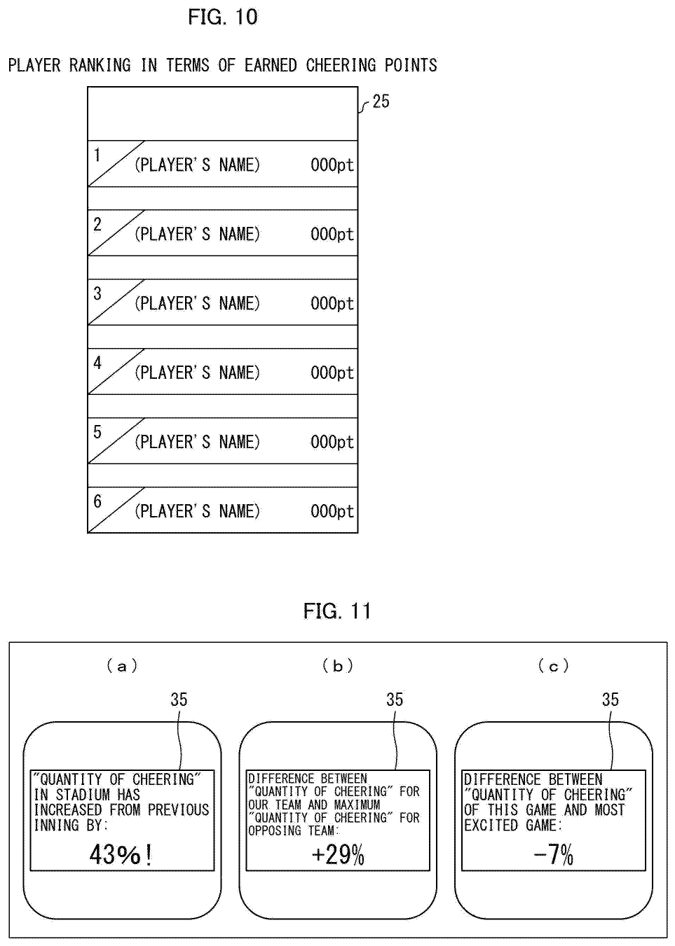

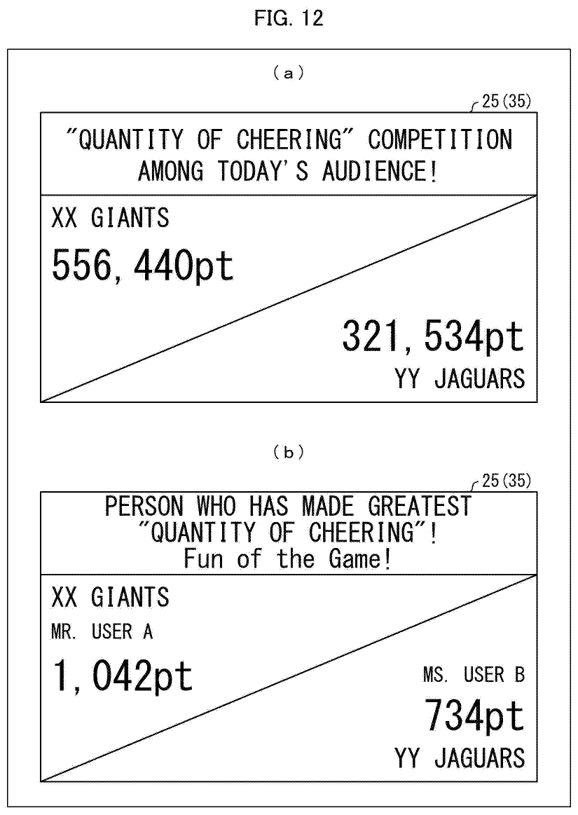

FIG. 10 illustrates an example of information about a player popularity poll, which information is displayed on the display section 25 of the mobile terminal 21.

The terminal apparatus 20 is capable of supplying, to the user, the information about the player popularity poll supplied from the information processing apparatus 10, by causing, at least one of (i) the display section 25 of the mobile terminal 21 and (ii) the display section 35 of the wearable terminal 30, to display the information.

As illustrated in FIG. 10, the control section 23 of the mobile terminal 21 controls the display section 25 to display the information about the player popularity poll which is acquired from the information processing apparatus 10 via the communication section 22. The display section 25 displays thereon a player popularity ranking in accordance with the points that the players have earned from users of terminal apparatuses 20.

The storage section 13 of the information processing apparatus 10 can be managed to store therein (i) each player's points that have been earned in a popularity poll in the today's event and (ii) the total number of points each player has earned so far in a popularity poll in this season. The user can acquire, from the information processing apparatus 10, at least one of (i) a player popularity ranking in the today's event and (ii) a player popularity ranking in this season, by conducting an operation with respect to either the mobile terminal 21 or the wearable terminal 30.

The storage section 13 of the information processing apparatus 10 can be configured to, for example, in a case where the event is a baseball game, be managed to store therein the sum ΣSₙ^{m} of scores Sn of the respective child terminal apparatuses 121, 122, and 123 (the sum is found by the control section 12) on a per-inning basis, on a per-unit-time basis, on a per-team's fans basis, and on a per-game basis in this season. The control section 12 of the information processing apparatus 10 can be configured to find a solidarity indicator while referring to (i) the sums ΣSₙ^{m} of scores Sn in respective innings, (ii) the sums ΣSₙ^{m} of scores Sn of fans of respective teams, and (iii) the sums ΣSₙ^{m} of scores Sn in respective games of this season.

FIG. 11 illustrates examples of a solidarity indicator displayed on the display section 35 of the wearable terminal 30.

The control section 12 of the information processing apparatus 10 can be configured to, for example, find how much percentage the “quantity of cheering” at a stadium has increased from that of the previous inning, while referring to the sum ΣSₙ^{m} of the scores Sn of the respective child terminal apparatuses 121, 122, and 123 stored on a per-inning basis in the storage section 13. The thus-found percentage serves as a solidarity indicator. The control section 12 of the information processing apparatus 10 can be configured to supply, to each of the terminal apparatuses 20 via the communication section 11, how much percentage the “quantity of cheering” at the stadium has increased from that of the previous inning.

Each of the terminal apparatuses 20 presents, to a user thereof, the solidarity indicator supplied from the information processing apparatus 10, by causing at least one of (i) the display section 25 of the mobile terminal 21 and (ii) the display section 35 of the wearable terminal 30 to display the solidarity indicator. For example, the control section 32 of the wearable terminal 30 controls the display section 35 to display how much percentage the “quantity of cheering” at the stadium has increased from that of the previous inning (see (a) of FIG. 11).

For example, the control section 12 of the information processing apparatus 10 can be configured to find a solidarity indicator while referring to (i) the sums ΣSₙ^{m} of scores Sn of fans of respective teams in the today's event, (ii) the sums ΣSₙ^{m} of scores Sn in respective innings in the today's event, or (iii) the sums ΣSₙ^{m} of scores Sn in respective unit times in the today's event, all of which are stored in the storage section 13. For example, the control section 12 can be configured to (i) find, as “quantity of cheering,” the sum ΣSₙ^{m} of current scores Sn of a certain team and (ii) compare the thus-found “quantity of cheering” with the maximum value of the sum ΣSₙ^{m} of scores Sn of the opposing team in the today's event. The control section 12 can be configured to thereby find a difference in percentage between the current “quantity of cheering” for the certain team and the maximum “quantity of cheering” for the opposing team in the today's event. The thus-found difference serves as a solidarity indicator. The control section 12 of the information processing apparatus 10 supplies the thus-found solidarity indicator to each of the terminal apparatuses 20 via the communication section 11.

Each of the terminal apparatuses 20 presents, to the user, the solidarity indicator received from the information processing apparatus 10, by causing at least one of (i) the display section 25 of the mobile terminal 21 and (ii) the display section 35 of the wearable terminal 30 to display the solidarity indicator. For example, the control section 32 of the wearable terminal 30 controls the display section 35 to display the difference in percentage between the current “quantity of cheering” and the maximum “quantity of cheering” for the opposing team (see (b) of FIG. 11).

The control section 12 of the information processing apparatus 10 can be configured to find a solidarity indicator while referring to, for example, the sums ΣSₙ^{m} of scores Sn in respective games in this season stored in the storage section 13. For example, the control section 12 of the information processing apparatus 10 can be configured to (i) find the sum ΣSₙ^{m} of current scores Sn as “quantity of excitement” and (ii) compare the thus-found “quantity of excitement” with the maximum “quantity of excitement” in this season. The control section 12 of the information processing apparatus 10 can be configured to thereby find a difference in percentage between the current “quantity of excitement” and the maximum “quantity of excitement” in this season. The thus-found difference serves as a solidarity indicator. The control section 12 of the information processing apparatus 10 supplies the thus-found solidarity indicator to each of the terminal apparatuses 20 via the communication section 11.

Each of the terminal apparatuses 20 presents, to the user, the solidarity indicator received from the information processing apparatus 10, by causing at least one of (i) the display section 25 of the mobile terminal 21 and (ii) the display section 35 of the wearable terminal 30 to display the solidarity indicator. For example, the control section 32 of the wearable terminal 30 controls the display section 35 to display the difference in percentage between the maximum “quantity of excitement” in this season and the current “quantity of excitement” (see (c) of FIG. 11).

FIG. 12 illustrates examples of another kind of solidarity indicator displayed on the display section 25 of the mobile terminal 21.

The storage section 13 of the information processing apparatus 10 is managed to store therein earned points (which have been found by the control section 12) on a per-team basis. For example, each of the terminal apparatuses 20 supplies, to the information processing apparatus 10, (i) a piece of data on oscillating motion and (ii) a piece of user information that is indicative of a team the user is cheering for or a team which the user is a fan of. The storage section 13 is managed to store therein earned points, which have been found by the control section 12, together with the pieces of user information. The control section 12 can be configured to be capable of finding earned points on a per-team basis in accordance with the information stored in the storage section 13.

The control section 12 of the information processing apparatus 10 is capable of determining to use, as a solidarity indicator, the total number of points earned so far by each team in the today's event, while referring to the information of earned points stored in the storage section 13.

The control section 12 of the information processing apparatus 10 supplies, to each of the terminal apparatuses 20, the thus-determined total number of points earned so far by each team in the today's event. Each of the terminal apparatuses 20 presents, to the user, the solidarity indicator received from the information processing apparatus 10, by causing at least one of (i) the display section 25 of the mobile terminal 21 and (ii) the display section 35 of the wearable terminal 30 to display the solidarity indicator. For example, the control section 23 of the mobile terminal 21 controls the display section 25 to display the total number of points earned so far by each team as illustrated in (a) of FIG. 12. Note that the following configuration can be employed: fans of opposing teams compete against each other in terms of the “quantity of cheering” during an interval between innings; and a result found by the control section 12 of the information processing apparatus 10 in this competition is displayed as illustrated in (a) of FIG. 12.

As has been described, the storage section 13 of the information processing apparatus 10 is managed to store therein the earned points (which have been found by the control section 12) on a per-user basis. The control section 12 of the information processing apparatus 10 can be configured to determine, while referring to points earned by users stored in the storage section 13, a user who has made the greatest quantity of cheering among each team's fans after the event.

The control section 12 of the information processing apparatus 10 supplies, to each of the terminal apparatuses 20, information of the thus-determined user who has made the greatest quantity of cheering among each team's fans. Each of the terminal apparatuses 20 presents, to a user thereof, the information received from the information processing apparatus 10 by causing at least one of (i) the display section 25 of the mobile terminal 21 and (ii) the display section 35 of the wearable terminal 30 to display the information. For example, the control section 23 of the mobile terminal 21 controls the display section 25 to display (i) the information of the user who has made the greatest quantity of cheering among each team's fans and (ii) the number of points earned by the user (see (b) of FIG. 12).

[Remarks]

The description in Embodiment 1 has discussed configurations in which the solidarity indicator is found in accordance with oscillating motion detected by the oscillating motion detecting section 33 of the wearable terminal 30. Note, however, that the configuration can be employed in which the solidarity indicator is found while referring to not only data on oscillating motion but also data on a sound collected by the microphone 24 of the mobile terminal 21. An example of such a configuration is as follows. Specifically, the control section 12 of the information processing apparatus 10 finds a solidarity indicator by multiplying, by a factor that varies in accordance with the data on a sound acquired from each of the child terminal apparatuses 121, 122, and 123, the sum ΣSₙ^{m} of scores Sn of all the child terminal apparatuses 121, 122, and 123.

Alternatively, each of one or more terminal apparatuses 20 can be configured to (i) have a function of detecting its own location information and (ii) transmit its own location information together with a piece of data on oscillating motion to the information processing apparatus 10. The control section 12 of the information processing apparatus 10 can be configured to find solidarity indicators for respective locations, such as places or regions, while referring to the pieces of data on oscillating motion and the pieces of location information (both of which have been acquired via the communication section 11) of the one or more terminal apparatuses 20.

The control section 12 of the information processing apparatus 10 can be configured to generate data related to solidarity indicators for respective events, while referring to solidarity indicators stored in the storage section 13. For example, the control section 12 can be configured, in a case of a baseball game, to (i) generate data obtained by associating each game's solidarity indicator with various kinds of information such as opposing teams, attending players, game situations, and game results, throughout a season and (ii) supply the data thus generated to each of the one or more terminal apparatuses 20 and to the external server 50.

### Embodiment 2

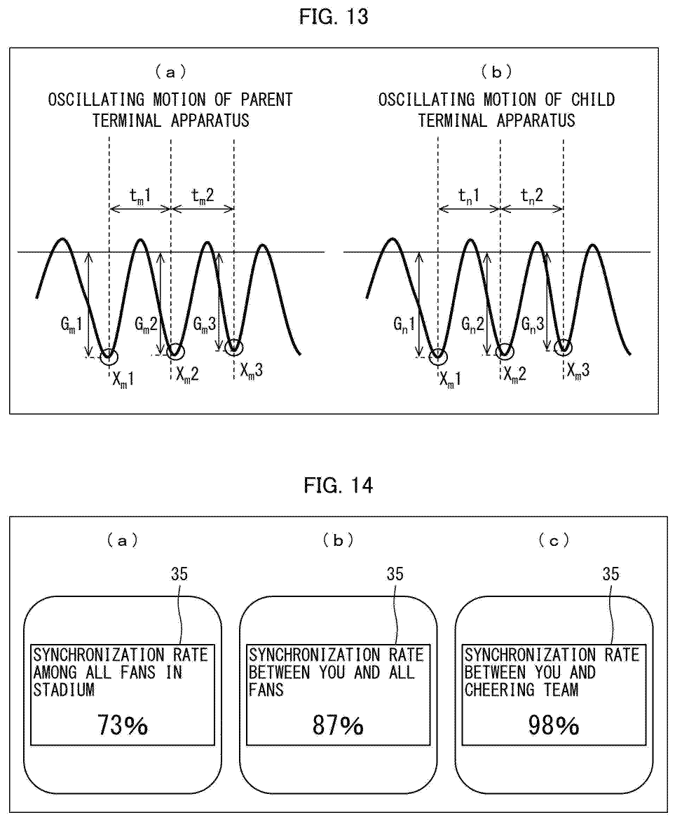

The following description will discuss Embodiment of the present invention with reference to FIG. 13. Note that an information processing system 1 of Embodiment 2 is equal in configuration to the information processing system 1 of Embodiment 1 discussed with reference to FIGS. 1 through 3, and its descriptions are omitted.

[Another Method of Finding Solidarity Indicator]

In Embodiment 1, the solidarity indicator is found based on the difference (Bm−Bn) between the number of beats Bm of the parent terminal apparatus 120 within a unit time T and the number of beats Bn of each of the child terminal apparatuses 121, 122, and 123 within the unit time T.

In Embodiment 2, the information processing apparatus 10 (i) refers to data on oscillating motion of the parent terminal apparatus 120 and data on oscillating motion of each of the child terminal apparatuses 121, 122, and 123, (ii) acquires durations of oscillations detected by each of the terminal apparatuses (the durations serve as data on a behavior of a user), and (iii) finds a solidarity indicator in regard to an event based on how the parent terminal apparatus 120 and each of the child terminal apparatuses 121, 122, and 123 are synchronized in terms of the durations of oscillations (i.e., based on the degree of synchronization, or synchronization rate).

FIG. 13 shows information about oscillating motion data of each terminal apparatus 20. (a) of FIG. 13 shows an example of data on oscillating motion of the parent terminal apparatus 120, and (b) of FIG. 13 shows an example of data on oscillating motion of each of the child terminal apparatuses 121, 122, and 123. The parent terminal apparatus 120 transmits, to the information processing apparatus 10, a piece of data on oscillating motion based on a sensor signal detected by the oscillating motion detecting section 33 of the wearable terminal 30. The information processing apparatus 10 finds, from the piece of data on oscillating motion acquired from the parent terminal apparatus 120, the number of beats Bm within a unit time T, magnitude Gm of acceleration caused by each beat, and duration tm of each beat.

Each of the child terminal apparatuses 121, 122, and 123 transmits, to the information processing apparatus 10, a piece of data on oscillating motion based on a sensor signal detected by the oscillating motion detecting section 33 of the wearable terminal 30. The information processing apparatus 10 finds, from the piece of data on oscillating motion acquired from each of the child terminal apparatuses 121, 122, and 123, the number of beats Bn within the unit time T, magnitude Gn of acceleration caused by each beat, and duration tn of each beat.

Note that the following configuration can be employed: the parent terminal apparatus 120 and the child terminal apparatuses 121, 122, and 123 each find the number of beats Bm or the number of beats Bn within a unit time T, the magnitude Gm or Gn of acceleration caused by each beat, and the duration tm or tn of each beat in accordance with the sensor signal detected by the oscillating motion detecting section 33 of each of their wearable terminals 30. This configuration can be configured such that the parent terminal apparatus 120 and the child terminal apparatus 121, 122, and 123 each transmit, to the information processing apparatus 10, the thus-found number of beats Bm within the unit time T or the number of beats Bn within the unit time T, the magnitude Gm or Gn of acceleration caused by each beat, and the duration tm or tn of each beat, which serve as data on oscillating motion.

The control section 12 of the information processing apparatus 10 can be configured to find a solidarity indicator in accordance with the degree of synchronization (synchronization rate) between (i) the number of beats Bm within the unit time T, the magnitude Gm of acceleration caused by each beat, and the duration tm of each beat acquired via the communication section 11 from the parent terminal apparatus 120 and (ii) the number of beats Bn within the unit time T, the magnitude Gn of acceleration caused by each beat, and the duration to of each beat acquired via the communication section 11 from each of the child terminal apparatuses 121, 122, and 123. The control section 12 of the information processing apparatus 10 can be configured to, for example, find (i) the synchronization rate between the piece of data on oscillating motion of the parent terminal apparatus 120 and the piece of data on oscillating motion of each of the child terminal apparatuses 121, 122, and 123 and (ii) find the solidarity indicator in accordance with the synchronization rate.

In this manner, the synchronization rate between the piece of data on oscillating motion of the parent terminal apparatus 120 and the piece of data on oscillating motion of each of the child terminal apparatuses 121, 122, and 123 is found, and the solidarity indicator is found in accordance with the synchronization rate. This makes it possible to more appropriately convert solidarity, which is intangible, into a numerical form.

[Example of how Solidarity Indicator Found in Accordance with Degree of Synchronization of Oscillating Motion is Displayed]

FIG. 14 illustrates examples of how a solidarity indicator, found in accordance with the degree of synchronization (synchronization rate) of oscillating motion, is displayed on the display section 35 of the wearable terminal 30.

Although FIG. 14 illustrates examples in which the solidarity indicator is displayed on the display section 35 of the wearable terminal 30, this does not intend to imply any limitation. The solidarity indicator can be displayed on the display section 25 of the mobile terminal 21.

The storage section 13 of the information processing apparatus 10 is managed to store therein the synchronization rates, found by the control sections 12, on a per-user basis. The solidarity indicator found by the control section 12 of the information processing apparatus 10 can be (i) a synchronization rate among all users in the today's event, (ii) a synchronization rate between a user of one of the terminal apparatuses 20 and all users, and/or (iii) a synchronization rate between the user of one of the terminal apparatuses 20 and the user of the parent terminal apparatus 120, all of which are found while referring to the synchronization rates stored in the storage section 13.

The control section 12 of the information processing apparatus 10 supplies, to each of the terminal apparatuses 20 via the communication section 11, the thus-found synchronization rate serving as a solidarity indicator.

FIG. 14 illustrates examples of the solidarity indicator displayed on the display section 35 of the wearable terminal 30.

The terminal apparatuses 20 presents, to a user thereof, the solidarity indicator provided from the information processing apparatus 10 by causing at least one of (i) the display section 25 of the mobile terminal and (ii) the display section 35 of the wearable terminal 30 to display the solidarity indicator.

The control section 12 of the information processing apparatus 10 finds the synchronization rate among oscillating motions of all users (all fans) in a stadium while referring to the pieces of data on oscillating motion acquired from respective terminal apparatuses 20 of all the users in the stadium. The synchronization rate serves as a solidarity indicator. The control section 12 of the information processing apparatus 10 supplies the thus-found solidarity indicator to each of the terminal apparatuses 20.

Each terminal apparatus 20 controls the display section 35 by the control section 32 of the wearable terminal 30 to display the synchronization rate in percentage among all the fans in the stadium (see (a) of FIG. 14).

The solidarity indicator found by the control section 12 of the information processing apparatus 10 can alternatively be a synchronization rate between a user of one of the terminal apparatuses 20 and all the users. The control section 12 of the information processing apparatus 10 supplies the thus-found solidarity indicator to each of the terminal apparatuses 20.

Each terminal apparatuses 20 controls the display section 35 by the control section 32 of the wearable terminal 30 to display the synchronization rate in percentage between the user of this terminal apparatus 20 and all users (see (b) of FIG. 14). As used herein, the term “all users” can either mean only those who are in the stadium or all users including those who are in the stadium and those who are watching a television broadcast or web broadcast.

The solidarity indicator found by the control section 12 of the information processing apparatus 10 can alternatively be a synchronization rate between a user of one of the terminal apparatuses 20 and the user of the parent terminal apparatus 120. The control section 12 of the information processing apparatus 10 finds the synchronization rate between the user of one of the terminal apparatuses 20 and the user of the parent terminal apparatus 120 while referring to a piece of data on oscillating motion of a percussionist of a cheering team and a piece of data on oscillating motion of the wearable terminal 30 of the user's terminal apparatus 20, as described earlier.

Each terminal apparatus 20 controls the display section 35 by the control section 32 of the wearable terminal 30 to display the synchronization rate in percentage between the user of this terminal apparatus 20 and the cheering team (see (c) of FIG. 14).

### Embodiment 3

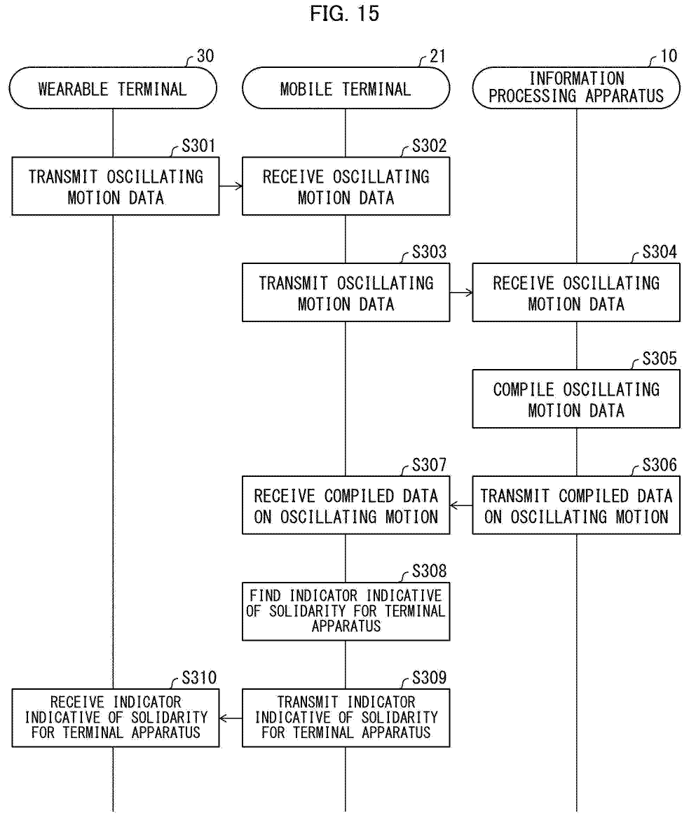

The following description will discuss Embodiment 3 of the present invention with reference to FIG. 15. Note that an information processing system 1 of Embodiment 3 is equal in configuration to the information processing system 1 of Embodiment 1 discussed with reference to FIGS. 1 through 3, and its descriptions are omitted.

Embodiment 1 has discussed configurations in which the control section 12 of the information processing apparatus 10 finds a solidarity indicator while referring to a piece(s) of data on a behavior(s) of a user(s) of a terminal apparatuses(es) 20 acquired via the communication section 11 (see FIG. 6). The description in Embodiment 3 discusses a configuration in which (i) a terminal apparatus 20 acquires, from the information processing apparatus 10, compiled data obtained by compiling a piece(s) of data on a behavior(s) of a user(s) of a terminal apparatus(es) 20 and (ii) the terminal apparatus 20 finds a solidarity indicator for a user thereof in regard to an event while referring to the compiled data thus acquired.

[Process of Finding Solidarity Indicator by Use of Terminal Apparatus]

FIG. 15 is a sequence diagram showing a process of finding a solidarity indicator by use of the information processing system 1 in accordance with Embodiment 3.

The following description will discuss steps of a process of finding a solidarity indicator with reference to FIG. 15.

(Step S301) The control section 32 of the wearable terminal 30 transmits, to the mobile terminal 21 via the communication section 31, a piece of data on oscillating motion based on a sensor signal detected by oscillating motion detecting section 33. The piece of data on oscillating motion is an example of data on a behavior of a user.

(Step S302)

The control section 23 of the mobile terminal 21 receives the piece of data on oscillating motion from the wearable terminal 30 via the communication section 22.

(Step S303)

The control section 23 of the mobile terminal 21 transmits the piece of data on oscillating motion to the processing apparatus 10 via the communication section 22.

The piece of data on oscillating motion of the terminal apparatus 20 transmitted from the terminal apparatus 20 to the information processing apparatus 10 is at least one of (i) magnitudes of acceleration caused by oscillations and (ii) the number of beats B (the number of oscillations). Both of the above (i) and (ii) are determined in accordance with the sensor signal detected by the oscillating motion detecting section 33 of the wearable terminal 30. The piece of data on oscillating motion can alternatively be found by the control section 32 of the wearable terminal 30 or by the control section 23 of the mobile terminal 21.

(Step S304)

The control section 12 of the information processing apparatus 10 receives and acquires the piece of data on oscillating motion from the terminal apparatus 20 via the communication section 11.

The information processing apparatus 10 acquires, from a terminal apparatus(es) 20, a piece(s) of such data on oscillating motion of the terminal apparatus(es) 20.

(Step S305)

The control section 12 of the information processing apparatus 10 compiles the piece(s) of data on oscillating motion of the terminal apparatus(es) 20 acquired via the communication section 11, and thereby generates compiled data. The compiled data generated by the control section 12 of the information processing apparatus 10 here is, for example, the sum ΣSₙ^{m} of scores Sn of the respective terminal apparatuses 20 (121, 122, 123 and so on) discussed in Embodiment 1.

(Step S306)

The control section 12 of the information processing apparatus 10 transmits, to the terminal apparatus(es) 20 via the communication section 11, the compiled data obtained by compiling the piece(s) of data on oscillating motion of the terminal apparatus(es) 20.

(Step S307)

The control section 23 of the mobile terminal 21 receives, from the information processing apparatus 10 via the communication section 22, the compiled data obtained by compiling the piece(s) of data on oscillating motion of the terminal apparatus(es) 20.

(Step S308)

The control section 23 of the mobile terminal 21 finds a solidarity indicator for a corresponding terminal apparatus 20 while referring to the compiled data obtained by compiling the piece(s) of data on oscillating motion of the terminal apparatus(es) 20 acquired via the communication section 22. For example, the control section 23 of the mobile terminal 21 receives, from the information processing apparatus 10, not only the compiled data ΣSₙ^{m} but also the score Sn thereof and the total number n of the terminal apparatuses 20. The control section 23 of the mobile terminal 21 can be configured to find a solidarity indicator for the terminal apparatus 20 by finding, based on the score Sn thereof and the total number n of the terminal apparatuses 20, the degree of contribution thereof to the compiled data ΣSₙ^{m}.

(Step S309)

The control section 23 of the mobile terminal 21 transmits the thus-found solidarity indicator to the wearable terminal 30 via the communication section 22.

(Step S310)

The control section 32 of the wearable terminal 30 receives the solidarity indicator via the communication section 31.

The calculation of the solidarity indicator for the terminal apparatus 20 while referring to the compiled data acquired from the information processing apparatus 10 can be carried out not only by the control section 23 of the mobile terminal 21. The calculation can alternatively be carried out by the control section 32 of the wearable terminal 30.

Each of the terminal apparatuses 20 can be configured to transmit the thus-found solidarity indicator thereof to the information processing apparatus 10 over the network 2. The control section 12 of the information processing apparatus 10 can be configured to find another indicator (e.g., “quantity of excitement”) while referring to the solidarity indicators acquired from the terminal apparatus(es) 20 and to provide the another indicator to the external server 50.

### Embodiment 4

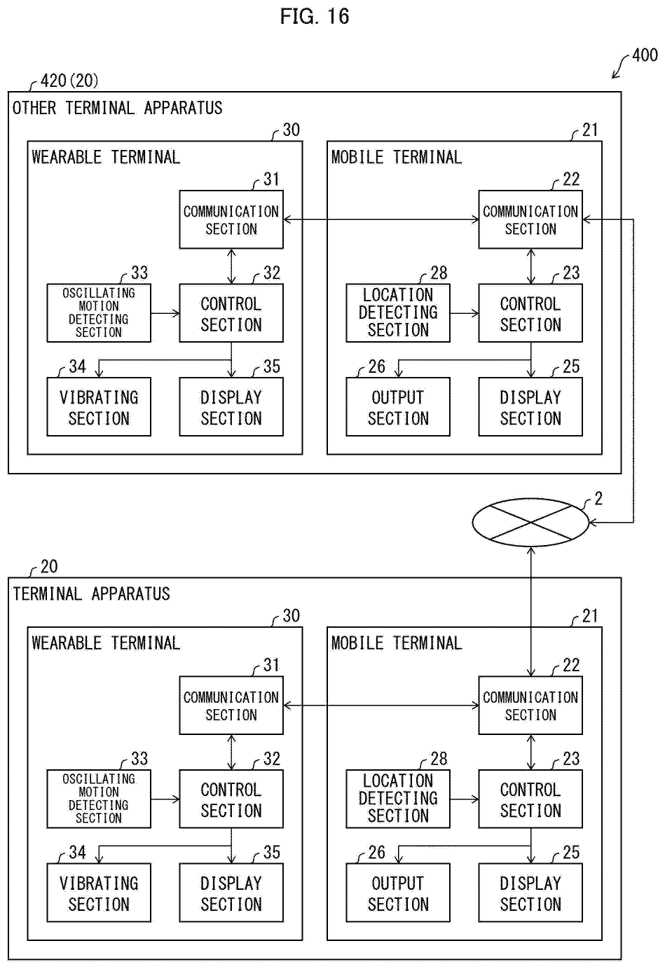

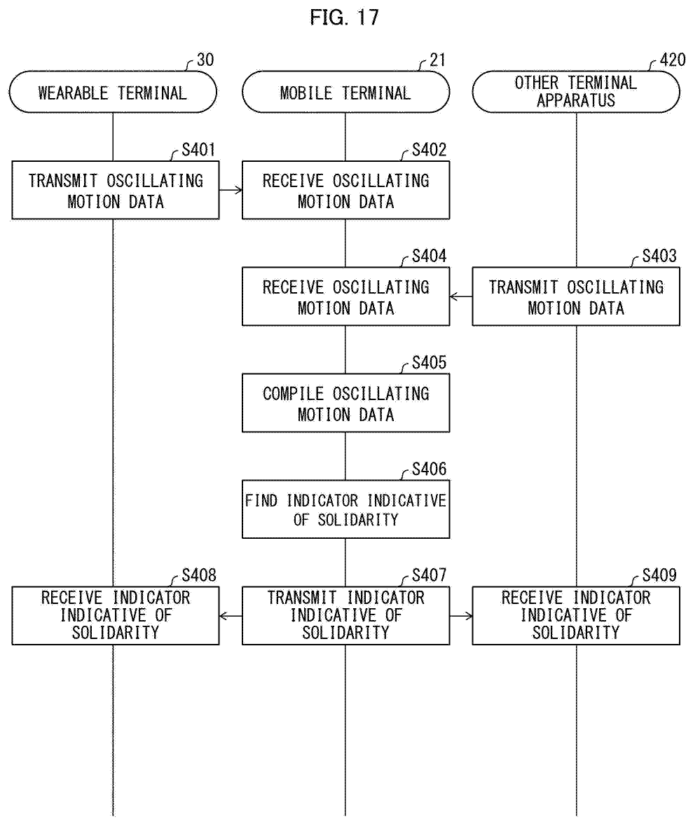

The following description will discuss Embodiment 4 of the present invention with reference to FIGS. 16 and 17. For convenience of description, members having functions identical to those discussed in Embodiments 1 through 3 are assigned identical referential numerals, and their descriptions are omitted here.

The following description discusses an example configuration in which the data on a behavior of a user is data on oscillating motion.

The foregoing information processing system 1 in accordance with each of Embodiments 1 through 3 is configured such that the information processing apparatus 10 and the terminal apparatus(es) 20 communicate with each other over the network 2 and find a solidarity indicator. The following description in Embodiment 4 discusses an information processing system 400 that does not include the information processing apparatus 10 and that is comprised of a terminal apparatus(es) 20.

FIG. 16 is a block diagram schematically illustrating a configuration of the information processing system 400.

As illustrated in FIG. 16, the information processing system 400 includes a plurality of terminal apparatuses 20 which are communicably connected to each other over a network 2.

Each of the terminal apparatuses 20 includes a mobile terminal 21 and a wearable terminal 30. The mobile terminal 21 of each of the terminal apparatuses 20 includes a location detecting section 28. The location detecting section 28 can include, for example, a GPS signal detecting section, a Wi-fi (registered trademark) wave detecting section, a gyroscope sensor, and/or the like. The location detecting section 28 provides a detection signal to a control section 23. The control section 23 determines its location while referring to the detection signal received from the location detecting section 28.

In the information processing system 400, at least one of the plurality of terminal apparatuses 20 functions as an information processing apparatus 10, and acquires a piece(s) of data on oscillating motion from respective other terminal apparatus(es) 420 (20). The control section 23 of the at least one terminal apparatus 20 can be configured to (i) identify other nearby terminal apparatus(es) 420 in accordance with the detection signal supplied from the location detecting section 28 and (ii) requests the thus-identified other nearby terminal apparatus(es) 420 to transmit a piece(s) of data on oscillating motion.

The at least one terminal apparatus 20 acquires the piece(s) of data on oscillating motion from the respective other terminal apparatus(es) 420 and finds an indicator indicative of solidarity between the at least one terminal apparatus 20 and the other terminal apparatus(es) 420 (this solidarity is solidarity for a user in regard to an event). A method of finding the solidarity indicator is the same as that discussed in Embodiment 1 or 2, and therefore descriptions therefor are omitted here.

For example, the at least one terminal apparatus 20 can be configured to (i) recognize at least one of the other terminal apparatus(es) 420 as a parent terminal apparatus 120 and (ii) find the solidarity indicator from a difference (Bm−Bn) in the number of beats between the thus-recognized parent terminal apparatus 120 and the terminal apparatus(es) 420. Alternatively, the at least one terminal apparatus 20 can be configured to (i) recognize itself as the parent terminal apparatus 120 and (ii) find a solidarity indicator while referring to the piece of data on oscillating motion thereof and the piece(s) of data on oscillating motion of the terminal apparatus(es) 420.

(Process of Finding Solidarity Indicator by Use of Terminal Apparatus while Referring to Data on Oscillating Motion Acquired from Other Terminal Apparatus(es))

FIG. 17 is a sequence diagram showing a process of finding a solidarity indicator by use of the information processing system 400.

The following description will discuss steps of a process of finding a solidarity indicator with reference to FIG. 17.

(Step S401)

In a terminal apparatus 20, the control section 32 of the wearable terminal 30 transmits, to the mobile terminal 21 via the communication section 31, a piece of data on oscillating motion based on a sensor signal detected by the oscillating motion detecting section 33.

(Step S402)

In the terminal apparatus 20, the control section 23 of the mobile terminal 21 receives the piece of data on oscillating motion from the wearable terminal 30 via the communication section (acquiring section) 22.

(Step S403)

The other terminal apparatus(es) 420 transmit a piece(s) of data on oscillating motion to the terminal apparatus 20.

(Step S404)

In the terminal apparatus 20, the control section of the mobile terminal 21 acquires the piece(s) of data on oscillating motion from the respective other terminal apparatus(es) 420 via the communication section 22.

(Step S405)

In the terminal apparatus 20, the control section 23 of the mobile terminal 21 compiles the piece of data on oscillating motion thereof and the piece(s) of data on oscillating motion of the respective other terminal apparatus(es) 420.

(Step S406)

In the terminal apparatus 20, the control section 23 of the mobile terminal 21 finds a solidarity indicator while referring to the piece of data on oscillating motion thereof and the piece(s) of data on oscillating motion of the respective other terminal apparatus(es) 420.

(Step S407)

In the terminal apparatus 20, the control section 23 of the mobile terminal 21 transmits the thus-found solidarity indicator to the wearable terminal 30 of the terminal apparatus 20 and to each of the other terminal apparatus(es) 420 via the communication section 22.

(Step S408)

The wearable terminal 30 of the terminal apparatus 20 receives the solidarity indicator via the communication section 31.

(Step S409)

Each of the other terminal apparatus(es) 420 receives the solidarity indicator from the terminal apparatus 20.

[Remarks]

As described earlier, the terminal apparatuses 20 and 420 each include the location detecting section 28. This makes it possible, for example, for people watching a baseball game at a stadium to share data on oscillating motion in accordance with location information such as those indicative of an area closer to the infield, an area closer to the outfield, or the like. The following configuration can also be employed: a terminal apparatus(es) at respective location(s) acquire a piece(s) of data on oscillating motion from respective other terminal apparatus(es) 420; and the terminal apparatus(es) each find a solidarity indicator that depends on the location information.

An indicator indicative of solidarity among not only fans who are watching a game or the like at a concert site or a stadium but also fans who are gathering, for example, at an event site such as a public viewing event site can also be found in accordance with the location information of the terminal apparatus 20 and those of the other terminal apparatus(es) 420.

Furthermore, the following configuration, which is not illustrated, can be employed: the terminal apparatus 20 transmits, to the external server 50, the solidarity indicator which has been found while referring to the piece(s) of data on oscillating motion acquired from the respective other terminal apparatus(es) 420, in accordance with the location information. The external server 50 can be configured to cause the display section 53 to display the solidarity indicator(s) acquired from the terminal apparatus(es) 20 each of which is in correspondence with location information. This makes it possible to show the indicators indicative of solidarity of fans who are watching a television broadcast or a web broadcast on, for example, a per-region basis.

### Embodiment 5

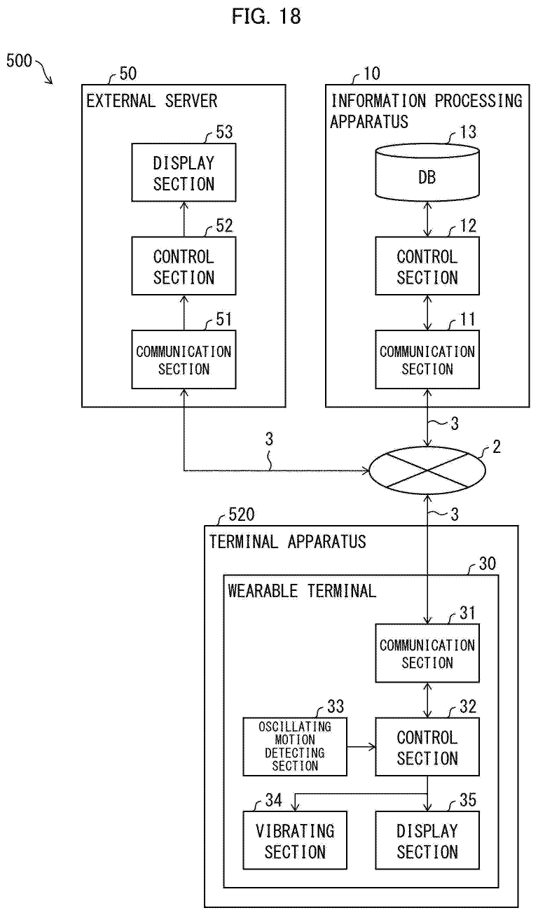

The following description will discuss Embodiment 5 of the present invention with reference to FIG. 18. For convenience of description, members having functions identical to those discussed in Embodiments 1 through 4 are assigned identical referential numerals, and their descriptions are omitted here.

The following description discusses an example configuration in which data on a behavior of a user is data on oscillating motion.

Embodiments 1 through 4 have discussed configurations in which each terminal apparatus 20 includes the mobile terminal 21 and the wearable terminal 30 and in which the mobile terminal 21 and the wearable terminal 30 communicate with each other via the near field communication link 4 such as Bluetooth (registered trademark).

FIG. 18 is a block diagram illustrating a configuration of main parts of an information processing system 500 in accordance with Embodiment 5. As illustrated in FIG. 18, the wearable terminal 30 of the information processing system 500 in accordance with Embodiment 5 is configured to be connectable directly to the network 2 such as the Internet by the radio communication link 3 via the communication section 31. As such, the wearable terminal 30, which is directly connectable to the network 2 via the radio communication link 3, does not need to communicate with the information processing apparatus 10 via the mobile terminal 21.

The information processing system 500 includes: a terminal apparatus 520 consisting only of the wearable terminal 30; an information processing apparatus 10, and an external server 50. The terminal apparatus 520 is configured such that the communication section 31 of the wearable terminal 30 and the communication section 11 of the information processing apparatus 10 are communicable with each other over the network 2. The terminal apparatus 520, through use of the control section 32 of the wearable terminal 30, provides, to the information processing apparatus 10 over the network 2, data on oscillating motion detected by the oscillating motion detecting section 33. The terminal apparatus 520, through use of the control section 32 of the wearable terminal 30, receives a solidarity indicator for a user in regard to an event from the information processing apparatus 10 via the communication section 31. The control section 32 of the wearable terminal 30 then presents, to the user, the solidarity indicator in the form of at least one of (i) vibration of the vibrating section 34 and (ii) display on the display section 35.

### Embodiment 6

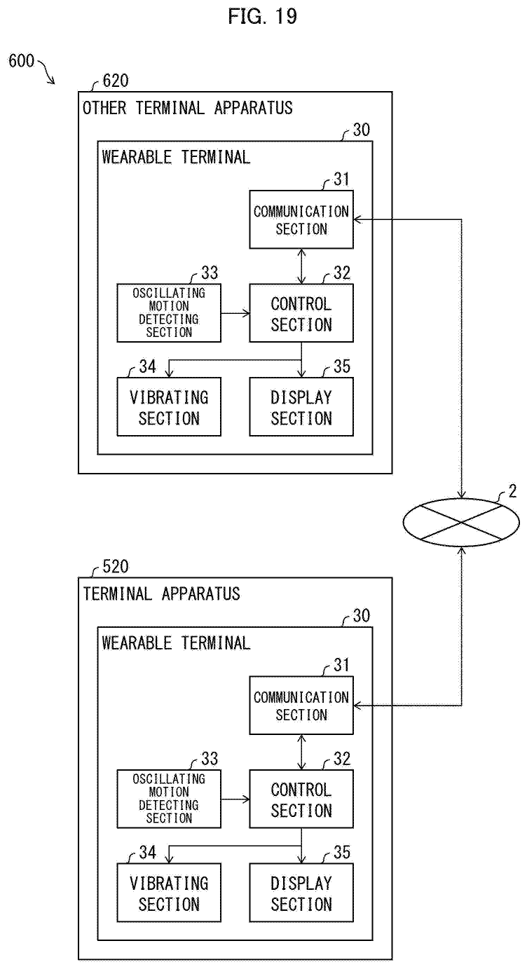

The following description will discuss Embodiment 6 of the present invention with reference to FIG. 19. For convenience of description, members having functions identical to those discussed in Embodiments 1 through 5 are assigned identical referential numerals, and their descriptions are omitted here.

The following description discusses an example configuration in which data on a behavior of a user is data on oscillating motion.

As described earlier in Embodiment 5, the wearable terminal 30 is connectable directly to the network 2 via the radio communication link 3.

FIG. 19 illustrates an information processing system 600 that includes a plurality of terminal apparatuses 520 which are connected to each other and communicable with each other over the network 2. As illustrated in FIG. 19, in the information processing system 600, each of the terminal apparatuses 520 is configured such that the communication section 31 of its wearable terminal 30 is communicable with the communication section(s) 31 of the wearable terminal(s) 30 of other terminal apparatus(es) 520 over the network 2. One of the terminal apparatus(es) 520 acquires a piece(s) of data on oscillating motion from the other terminal apparatus(es) 520 over the network 2, and finds a solidarity indicator for a user thereof in regard to an event. The one of the terminal apparatus(es) 520 then transmits the thus-found solidarity indicator to each of the other terminal apparatus(es) 520. The one of the terminal apparatus(es) 520, through use of the control section 32 of the wearable terminal 30, presents the solidarity indicator to the user in the form of at least one of (i) vibration of the vibrating section 34 and (ii) display on the display section 35.

### Embodiment 7

Embodiments 1 through 6 have discussed example configurations in which one information processing apparatus 10 is employed. Note, however, that the functions of the information processing apparatus 10 can be realized by separate servers. In a case where two or more servers are used, the servers may be managed by the same operator or by different operators.

### Embodiment 8

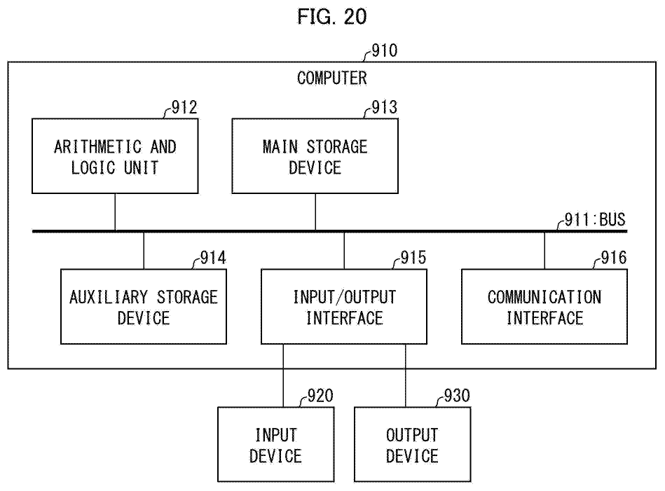

Each block of the information processing apparatus 10, the external server 50, and the terminal apparatus 20 can be realized by a logic circuit (hardware) provided in an integrated circuit (IC chip) or the like or can be alternatively realized by software. In the latter case, the information processing apparatus 10, the external server 50, and the terminal apparatus 20 can each be realized by a computer (electronic computer) as illustrated in FIG. 20.

FIG. 20 is a block diagram illustrating an example configuration of a computer 910 by which the information processing apparatus 10, the external server 50, and the terminal apparatus 20 can be realized. The computer 910 includes an arithmetic and logic unit 912, a main storage device 913, an auxiliary storage device 914, an input/output interface 915, and a communication interface 916 that are connected to each other via a bus 911. The arithmetic and logic unit 912, the main storage device 913, and the auxiliary storage device 914 can each be realized by, for example, one or more processors (e.g., one or more central processing units [CPUs]), a random access memory (RAM), or a hard disk drive. The input/output interface 915 is connected with (i) an input device 920 via which a user inputs various information into the computer 910 and (ii) an output device 930 via which the computer 910 outputs various information to the user. The input device 920 and the output device 930 can each be embedded in the computer 910 or can be alternatively connected to the computer 910 (externally connected to the computer 910). For example, the input device 920 can be a keyboard, a mouse, a touch sensor, or the like, and the output device 930 can be a display, a printer, a speaker, or the like. Alternatively, a device having both of a function of the input device 920 and a function of the output device 930 (such as a touch panel into which a touch sensor and a display are integrated) can be employed. The communication interface 916 is an interface via which the computer 910 communicates with an external device.

The auxiliary storage device 914 stores various programs for causing the computer 910 to operate as the information processing apparatus 10, the external server 50, or the terminal apparatus 20. The arithmetic and logic unit 912 causes the computer 910 to operate as sections included in the information processing apparatus 10, the external server 50, or the terminal apparatus 20 by (i) loading, onto the main storage device 913, the programs stored in the auxiliary storage device 914 and (ii) executing instructions carried out in the programs. Note that a recording medium which is included in the auxiliary storage device 914 for recording information, such as the various programs, only needs to be a computer-readable “non-transitory tangible medium.” Examples of the recording medium include tapes, disks, cards, semiconductor memories, and programmable logic circuits. In a case of a computer that is capable of executing the programs stored in the recording medium without having to load them onto the main storage device 913, the main storage device 913 is not essential.

The programs can be obtained from outside of the computer 910. In such a case, the programs can be obtained via any transmission medium (such as a communication network or a broadcast wave). The present invention can also be achieved in the form of a computer data signal in which the programs are embodied via electronic transmission and which is embedded in a carrier wave.

Aspects of the present invention can also be expressed as follows:

An information processing apparatus 10 in accordance with Aspect 1 of the present invention includes: a communication section 11 configured to communicate with a terminal apparatus 20; a storage section 13 configured to store therein an association between an event and the terminal apparatus 20; and a control section 12 configured to: acquire a piece of data on a behavior of a user from the terminal apparatus 20 via the communication section, and find an indicator that is indicative of solidarity in regard to the event while referring to predetermined reference data and the piece of data on the behavior of the user thus acquired.

According to the above arrangement, a solidarity indicator in regard to the event is found while referring to data on a behavior of a user of each of the terminal apparatus(es) 20. This makes it possible to find a solidarity indicator based on data that corresponds to a movement of a user who carries a terminal apparatus 20. This makes it possible, in the event, to convert the solidarity among users into a numerical form in accordance with, for example, a movement of a user such as beating time with hands. This makes it possible to convert solidarity, which originally is intangible, into a numerical form, and thus allows users to feel solidarity more accurately.

In Aspect 2 of the present invention, an information processing apparatus 10 is arranged such that, in Aspect 1, the predetermined reference data is a piece of data on a behavior of another user acquired via the communication section.

According to the above arrangement, the solidarity indicator can be found by using, as the reference data, data on a behavior of at least one user acquired via the communication section.

In Aspect 3 of the present invention, an information processing apparatus 10 is arranged such that, in Aspect 1, the predetermined reference data is a piece of data that has been pre-stored in the storage section 13.

According to the above arrangement, the solidarity indicator can be found based on the reference data found by, for example, statistical processing.

In Aspect 4 of the present invention, an information processing apparatus 10 can be arranged such that, in any of Aspects 1 through 3, the piece of data on the behavior of the user acquired by the control section 12 is a piece of data that indicates the number of oscillations within a unit time detected by the terminal apparatus 20.

According to the above arrangement, the indicator can be found in a preferred manner by (i) acquiring the number of oscillations within a unit time detected by the terminal apparatus, the number serving as the data on the behavior of the user, and (ii) referring to this data.

In Aspect 5 of the present invention, an information processing apparatus 10 can be arranged such that, in any of Aspects 1 through 4, the piece of data on the behavior of the user acquired by the control section 12 is a piece of data that indicates magnitudes of acceleration caused by respective oscillations detected by the terminal apparatus 20.

According to the above arrangement, the indicator can be found in a preferred manner by (i) acquiring a piece of data indicative of the magnitudes of acceleration caused by respective oscillations detected by the terminal apparatus(es), the piece of data serving as the piece of data on the behavior of the user, and (ii) referring to this data.

In Aspect 6 of the present invention, an information processing apparatus 10 can be arranged such that, in any of Aspects 1 through 5: the terminal apparatus 20 is composed of a plurality of terminal apparatuses 20; the piece of data on the behavior of the user acquired by the control section 12 is a piece of data that indicates durations of oscillations detected by each of the plurality of terminal apparatuses 20; and the control section is configured to find the indicator based on how the plurality of terminal apparatuses are synchronized in terms of the durations of the oscillations.

According to the above arrangement, the indicator is found based on how a plurality of terminal apparatuses 20 are synchronized in terms of the durations of the oscillations. This makes it possible to convert solidarity, which originally is intangible, into a numerical form more accurately.

In Aspect 7 of the present invention, an information processing apparatus 10 can be arranged such that, in Aspect 6: the control section 12 is configured to (i) acquire pieces of data on behaviors of users from the respective plurality of terminal apparatuses 20 and (ii) find the indicator based on how the pieces of data on the behaviors of the users thus acquired are synchronized.

According to the above arrangement, it is possible to find the indicator from the degree of synchronization between a plurality of users.

In Aspect 8 of the present invention, an information processing apparatus 10 can be arranged such that, in Aspect 6: the control section is configured to (i) acquire, from each of the plurality of terminal apparatuses, the piece of data on the behavior of the user and (ii) find the indicator in accordance with the piece of data on the behavior of the user thus acquired and the predetermined reference data pre-stored in the storage section.

According to the above arrangement, it is possible to find the indicator based on a deviation, from the reference data, of a piece of data on a behavior of a specific user.

In Aspect 9 of the present invention, an information processing apparatus 10 can be arranged such that, in any of Aspects 1 through 8, the communication section 11 further has a function of an output section, and the control section 12 is configured to supply the indicator thus found to an external server 50 via the communication section 11.

According to the above arrangement, it is possible to supply, to the external server 50, the indicator found while referring to the pieces of data on oscillating motion acquired from the respective terminal apparatus(es) 20. This makes it possible for the external server 50 to, for example, display the indicator on a large-scale video screen installed in an event site and to thereby present the indicator to an audience at the event site and people who watch the event through television/web. As such, the indicator is provided in a visible manner, making it possible to further pump up the event.

In Aspect 10 of the present invention, an information processing apparatus 10 can be arranged such that, in any of Aspects 1 through 8, the communication section 11 has a function of an output section, and the control section 12 is configured to supply the indicator thus found to the terminal apparatus 20 via the communication section 11.

According to the above arrangement, the indicator found by the information processing apparatus 10 can be checked on a terminal apparatus 20. This makes it possible for a user who carries the terminal apparatus 2 to know the indicator in the form of display on the terminal apparatus 20, sound output from the terminal apparatus 20, and/or vibration of a vibrator of the terminal apparatus 20. As such, it is possible to present the indicator in a manner that is easy for the user to recognize.

In Aspect 11 of the present invention, an information processing apparatus 10 can be arranged such that, in any of Aspects 1 through 10, the information processing apparatus 10 further includes a storage section 13, and the control section 12 is configured to store, in the storage section 13, the indicator thus found.

According to the above arrangement, it is also possible to generate data that varies in accordance with passage of time or changes in situations such as game situations, with use of the indicator stored in the storage section 13. This makes it possible to convert solidarity, which originally is intangible, into a numerical form, and to present such visible information to the user.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 400, 500, 600 information processing system
2 network
3 radio communication link
4 near field communication link
5 data providing server
10 information processing apparatus
11 communication section (acquiring section, output section)
12 control section
13 storage section
21 mobile terminal
20, 420, 520 terminal apparatus
22 communication section
23 control section
24 microphone
25 display section
26 output section
28 location detecting section
30 wearable terminal
31 communication section
32 control section
33 oscillating motion detecting section (behavior detecting section)
34 vibrating section
35 display section
50 external server
51 communication section
52 control section
53 display section
121, 122, 123 child terminal apparatus

1. An information processing apparatus, comprising:
a communication section configured to communicate with a terminal apparatus;
a storage section configured to store therein an association between an event and the terminal apparatus; and
a control section configured to:
acquire a piece of data on a behavior of a user from the terminal apparatus via the communication section, and
find an indicator that is indicative of solidarity in regard to the event while referring to predetermined reference data and the piece of data on the behavior of the user thus acquired.

2. The information processing apparatus as set forth in claim 1, wherein the predetermined reference data is a piece of data on a behavior of another user acquired via the communication section.

3. The information processing apparatus as set forth in claim 1, wherein the predetermined reference data is a piece of data that has been pre-stored in the storage section.

4. The information processing apparatus as set forth in claim 1, Wherein the piece of data on the behavior of the user acquired by the control section is a piece of data that indicates the number of oscillations within a unit time detected by the terminal apparatus.

5. The information processing apparatus as set forth in claim 1, wherein the piece of data on the behavior of the user acquired by the control section is a piece of data that indicates magnitudes of acceleration caused by respective oscillations detected by the terminal apparatus.

6. The information processing apparatus as set forth in claim 1, wherein:
the terminal apparatus is composed of a plurality of terminal apparatuses;
the piece of data on the behavior of the user acquired by the control section is a piece of data that indicates durations of oscillations detected by each of the plurality of terminal apparatuses; and
the control section is configured to find the indicator based on how the plurality of terminal apparatuses are synchronized in terms of the durations of the oscillations.

7. The information processing apparatus as set forth in claim 6, wherein:
the control section is configured to (i) acquire pieces of data on behaviors of users from the respective plurality of terminal apparatuses and (ii) find the indicator based on how the pieces of data on the behaviors of the users thus acquired are synchronized.

8. The information processing apparatus as set forth in claim 6, wherein
the control section is configured to (i) acquire, from each of the plurality of terminal apparatuses, the piece of data on the behavior of the user and (ii) find the indicator in accordance with the piece of data on the behavior of the user thus acquired and the predetermined reference data.

9. An information processing apparatus as set forth in claim 1, further comprising an output section,
the control section being configured to supply the indicator thus found to an external server, via the output section.

10. An information processing apparatus as set forth in claim 1, further comprising an output section,
the control section being configured to supply the indicator thus found to the terminal apparatus, via the output section.

11. An information processing apparatus as set forth in claim 1, wherein:
the control section being configured to store, in said storage section, the indicator thus found.

12. A terminal apparatus, comprising:
a communication section configured to communicate with an information processing apparatus;
a behavior detecting section configured to detect a behavior of a user; and
a control section configured to supply, to the information processing apparatus via the communication section, a piece of data on the behavior of the user detected by the behavior detecting section.

13. A terminal apparatus, associated with an event, comprising:
a communication section configured to communicate with an information processing apparatus;
a behavior detecting section configured to detect a behavior of a user; and
a control section configured to:
(i) acquire, via the communication section, data on a behavior of a user of the terminal apparatus, the data having been compiled by the information processing apparatus and being used as compiled data,
(ii) refer to the compiled data and data on the behavior of the user detected by the behavior detecting section, and
(iii) find an indicator that is indicative of solidarity for the user or for all users in regard to the event.

14. A terminal apparatus, associated with an event, comprising:
a communication section configured to communicate with one or more other terminal apparatuses;
a behavior detecting section configured to detect a behavior of a user; and
a control section configured to find an indicator that is indicative of solidarity for the user or for all users in regard to the event, while referring to (i) a piece of data on the behavior of the user detected by the behavior detecting section and (ii) one or more pieces of data on a behavior(s) of a user(s) of the respective one or more other terminal apparatuses, the one or more pieces of data having been acquired via the communication section.

15. An information processing system, comprising:
an information processing apparatus that includes a communication section, a control section, and an output section; and
a terminal apparatus which is associated with an event,
the control section being configured to:
(i) find an indicator that is indicative of solidarity for a user of the terminal apparatus or for all users of two or more of the terminal apparatuses in regard to the event while referring to data on a behavior of the user acquired by the communication section; and
(ii) supply the indicator thus found to one or more of the terminal apparatuses.

16. An information processing system, comprising:
an information processing apparatus that includes a communication section and a control section;
a terminal apparatus which is associated with an event; and
an external server,
the control section being configured to:
(i) find an indicator that is indicative of solidarity for a user of the terminal apparatus or for all users of two or more of the terminal apparatuses in regard to the event while referring to data on a behavior of the user acquired by the communication section, and
(ii) supply the indicator thus found to at least one of (a) one or more of the terminal apparatuses and (b) one or more of the external servers.

17. A computer-readable non-transitory recording medium on which a program for causing a computer to function as an information processing apparatus recited in claim 1 is stored, the program causing the computer to function as the control section.

18. A computer-readable non-transitory recording medium on which a program for causing a computer to function as a terminal apparatus recited in claim 12 is, the program causing the computer to function as the control section.

19. A method of controlling an information processing apparatus that includes (i) a communication section configured to communicate with a terminal apparatus associated with an event and (ii) a control section,
said method comprising the steps of:
(a) acquiring a piece of data on a behavior of a user from a terminal apparatus; and
(b) finding, while referring to the piece of data thus acquired, an indicator that is indicative of solidarity for the user or for all users in regard to the event.
